(19) United States
(12) Patent Application Publication
(10) Pub. No.: US 2022/0076095 A1
(43) Pub. Date: Mar. 10, 2022

(54) MULTI-LEVEL SPARSE NEURAL NETWORKS WITH DYNAMIC REROUTING

(71) Applicant: ALIBABA GROUP HOLDING LIMITED, George Town (KY)

(72) Inventors: Minghai QIN, San Mateo, CA (US); Tianyun ZHANG, San Mateo, CA (US); Fei SUN, San Mateo, CA (US); Yen-Kuang CHEN, San Mateo, CA (US)

(21) Appl. No.: 17/012,802

(22) Filed: Sep. 4, 2020

(51) Int. Cl. G06N 3/04; G06N 3/08

(52) U.S. Cl. CPC G06N 3/04; G06N 3/08

(57) ABSTRACT

Systems and methods for providing a neural network with multiple sparsity levels include sparsifying a matrix associated with the neural network to form a first sparse matrix; training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix includes the non-zero elements of the first sparse matrix; and outputting the second sparse matrix for executing the neural network.

### BACKGROUND

Deep neural networks (DNNs) have been used in many real life applications, such as object recognition, autonomous driving, language translation, image/video super resolution, or virtual/augmented reality. Modern neural networks often include many nodes and many layers. However, this reduces efficiency in execution and increases latency. Accordingly, input sparsity, output sparsity, and weight sparsity have all been proposed, individual or in combination, to increase efficiency and reduce latency. Indeed, sparsity in an artificial neural network more accurately reflects how neurons in a human brain process information. However, sparse matrices in neural networks can lead to significant inefficiencies in both storage and computation. For example, they require an unnecessarily large amount of storage space, which is largely occupied by zeros. In addition, computations on sparse matrices involve a large number of unnecessary operations (such as additions and multiplications) on zero elements.

### SUMMARY OF THE DISCLOSURE

In an aspect, a system for providing a neural network with multiple sparsity levels is provided. The system includes at least one memory for storing instructions and at least one processor configured to execute the instructions to cause the system to perform: sparsifying a matrix associated with the neural network to form a first sparse matrix; training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix includes the non-zero elements of the first sparse matrix; and outputting the second sparse matrix for executing the neural network.

In another aspect, a non-transitory computer-readable medium is provided. The non-transitory computer-readable medium stores a set of instructions that is executable by at least one processor of a computer to cause the computer to perform a method for providing a neural network with multiple sparsity levels. The method includes: sparsifying a matrix associated with the neural network to form a first sparse matrix; training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix includes the non-zero elements of the first sparse matrix; and outputting the second sparse matrix for executing the neural network.

In another aspect, a computer-implemented method for providing a neural network with multiple sparsity levels is provided. The method includes: sparsifying a matrix associated with the neural network to form a first sparse matrix; training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix includes the non-zero elements of the first sparse matrix; and outputting the second sparse matrix for executing the neural network.

In another aspect, a system for executing a neural network with multiple sparsity levels is provided. The system includes at least one memory for storing instructions and at least one processor configured to execute the instructions to cause the system to perform: receiving a first sparse matrix associated with a layer of the neural network; determining whether an inference status meets a predetermined condition; executing the layer using the first sparse matrix if the inference status does not meet the predetermined condition; and executing the layer using a second sparse matrix determined based on the first sparse matrix if the inference status meets the predetermined condition, wherein the second matrix and the first matrix have different sparsity levels, non-zero elements of the first sparse matrix include non-zero elements of the second sparse matrix, and the non-zero elements of the second sparse matrix have the same locations in the first sparse matrix and in the second sparse matrix.

In another aspect, a non-transitory computer-readable medium is provided. The non-transitory computer-readable medium stores a set of instructions that is executable by at least one processor of a computer to cause the computer to perform a method for executing a neural network with multiple sparsity levels. The method includes: receiving a first sparse matrix associated with a layer of the neural network; determining whether an inference status meets a predetermined condition; executing the layer using the first sparse matrix if the inference status does not meet the predetermined condition; and executing the layer using a second sparse matrix determined based on the first sparse matrix if the inference status meets the predetermined condition, wherein the second matrix and the first matrix have different sparsity levels, non-zero elements of the first sparse matrix include non-zero elements of the second sparse matrix, and the non-zero elements of the second sparse matrix have the same locations in the first sparse matrix and in the second sparse matrix.

In another aspect, a computer-implemented method for executing a neural network with multiple sparsity levels is provided. The method includes: receiving a first sparse matrix associated with a layer of the neural network; determining whether an inference status meets a predetermined condition; executing the layer based on the determination, wherein the layer is executed using the first sparse matrix in response to the inference status not meeting the predetermined condition and is executed using a second sparse matrix determined based on the first sparse matrix in response to the inference status meeting the predetermined condition, wherein the second matrix and the first matrix have different sparsity levels, non-zero elements of the first sparse matrix include non-zero elements of the second sparse matrix, and the non-zero elements of the second sparse matrix have the same locations in the first sparse matrix and in the second sparse matrix.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1A is a schematic representation of a neural network, consistent with some embodiments of this disclosure.

FIG. 1B is a schematic representation of an example sparsification of a matrix, consistent with some embodiments of this disclosure.

FIG. 1C is a schematic representation of another example sparsification of a matrix, consistent with some embodiments of this disclosure.

FIG. 2A is a schematic representation of an example configuration of a neural network accelerator, consistent with some embodiments of this disclosure.

FIG. 2B is a schematic representation of an example configuration of a core of a neural network accelerator, consistent with some embodiments of this disclosure.

FIG. 2C is a schematic representation of an example configuration of an operation unit of a core of a neural network accelerator, consistent with some embodiments of this disclosure.

FIG. 2D is a schematic representation of an example cloud system that includes a neural network accelerator, consistent with some embodiments of this disclosure.

FIG. 3 is a schematic representation of an example process of sparsifying and re-densing a matrix of a multi-level sparse neural network, consistent with some embodiments of this disclosure.

FIG. 4 is a schematic representation of an example process of executing a neural network with multiple sparsity levels, consistent with some embodiments of this disclosure.

FIG. 5 is a schematic representation of another example process of executing a neural network with multiple sparsity levels, consistent with some embodiments of this disclosure.

FIG. 6 illustrates a flowchart of an example method for providing a neural network with multiple sparsity levels, consistent with some embodiments of this disclosure.

FIG. 7 illustrates a flowchart of an example method for executing a neural network with multiple sparsity levels, consistent with some embodiments of this disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses, systems and methods consistent with aspects related to the invention as recited in the appended claims.

Neural network models (e.g., DNNs) usually include a massive number of weights, which can consume large computation and storage resources and impose challenges for deploying them to devices that have limited computation capacity, such as internet-of-things (IoT) devices or mobile devices (e.g., a smartphone). One approach to cope with such challenges is to reduce the size of the neural networks by sparsification (or “pruning”): a technique to identify and set non-critical weights in the neural networks to be zeroes while minimally reducing the accuracy loss by adjusting (e.g., quantizing) values of the remaining weights. Sparsification can be implemented as software (e.g., an algorithm) or hardware (e.g., a specific circuit). To generate a sparse neural network from a neural network (referred to as a “dense” neural network), one or more matrices (e.g., a weight matrix, an activation matrix, an input matrix, or any matrix) associated with the neural network can be sparsified and represented as sparsity representations or formats. The sparsity representations can include, for example, a compressed sparse row (CSR) format, a compressed sparse column (CSC) format, a dictionary of keys (DOK) format, a list of list (LIL) format, a coordinate list (COO) format, or any representation that employs a format of non-zero elements plus indexes to represent a sparse matrix.

However, a single sparse neural network can still be insufficient for some applications with different optimization objectives or under different environments. For example, a mobile phone can allocate more computation capacity and power budget when it is fully charged or is at low temperature, and can reduce its processor frequency for cooling down when its thermal limit is reached (referred to as “thermal throttling”), which significantly reduces its computation capacity. When the available computational or storage resources are low, the time between inputting and outputting of a neural network (referred to as “inference latency”) can increase and become noticeable for a user, and the quality of service (QoS) can be difficult to maintain. Some devices can employ multiple neural networks with different sparsity levels to mitigate such challenges. A sparsity level of a matrix can be a value of (1−A/B), where A represents a number of non-zero elements of the matrix, and B represents a total number of elements of the matrix. For example, those neural networks can include a less-sparse neural network (also referred to as a “small” neural network in this disclosure) that is more accurate but consumes more resources, and a more-sparse neural network (also referred to as a “tiny” neural network in this disclosure) that is more efficient but less accurate.

Some technical solutions maintain multiple sparse neural networks at different sparsity levels for increasing application efficiency under different environments. Nevertheless, those technical solutions typically store the multiple sparse neural networks separately, which requires large storage resources and can be undesirable.

Some embodiments of this disclosure provide apparatuses, systems, and methods for providing a single, multi-level sparse neural network that can provide multiple sparse neural networks with multiple sparsity levels. The multi-level sparse neural network can use a hierarchical structure to store parameters (e.g., matrix weights) for the multiple sparse neural networks with multiple sparsity levels such that parameters (e.g., locations and values of non-zero matrix elements) of a more-sparse model (e.g., a “tiny” model) are a subset of parameters (e.g., locations and values of non-zero matrix elements) a less-sparse model (e.g., a “small” model). In accordance with the hierarchical structure, parameters (e.g., non-zero matrix weights) and hyper parameters (e.g., biases, weights related to batch normalization, running means, or running variances) of the multiple sparse neural networks can be decoded from the single, multi-level sparse neural network. By doing so, the storage cost can be capped by the least sparse (or the most dense) model.

Some embodiments of this disclosure also provide apparatuses, systems, and methods for utilizing the multi-level sparse neural network. During execution (referred to as “inference”) of the multi-level sparse neural network, an appropriate sparsity level can be dynamically selected in response to an inference status (e.g., a predicted inference latency or a predicted processor utilization rate) estimated based on a runtime environment condition or a preset triggering condition. By doing so, unexpected inference latency can be reduced or eliminated, while computation complexity and accuracy can be well-balanced. The apparatuses, systems, and methods provided herein can eventually maintain the QoS and improve user experience of applications that implement neural networks.

For example, a device (e.g., a smartphone with its processor at full capacity) can start the inference using the less-sparse model decoded from the multi-level sparse neural network. When a runtime device condition changes (e.g., the processor being thermal throttled) and inference latency is estimated to increase, the device can decode the more-sparse model from the multi-level sparse neural network and switch (“reroute”) to use it for reducing inference latency. In another example, the same multi-level sparse neural network can be implemented as a specific circuit, which can be further integrated into devices having different computational capacities, such as IoT devices and smartphones. A device can detect availability of its computation resources and enable the specific circuit to select a sparse neural network of an appropriate sparsity level before the inference, such as selecting the more-sparse model on an IoT device or selecting the less-sparse model on a smartphone. By doing so, device manufacturers can use the same specific circuit on a wide variety of devices, which can simplify the designing and manufacturing processes and lower the manufacturing cost.

Aspects of this disclosure can relate to providing a neural network with multiple sparsity levels, including systems, apparatuses, methods, and non-transitory computer-readable media. For ease of description, a method is described below, with the understanding that aspects to the method apply equally to systems, apparatuses, and non-transitory computer-readable media. For example, some aspects of such a method can be implemented by a system, an apparatus, or as program codes or computer instructions stored in a non-transitory computer-readable medium. In a broadest sense, the method is not limited to any particular physical or electronic instrumentalities, but rather can be accomplished using many different instrumentalities.

The “neural network,” as used herein, can refer to a computing model for analyzing underlying relationships in a set of input data by way of mimicking human brains. Similar to a biological neural network, the neural network can include a set of connected units or nodes (referred to as “neurons”), structured as different layers, where each connection (also referred to as an “edge”) can receive and send a signal between neurons of neighboring layers in a way similar to a synapse in a biological brain. The signal can be any type of data (e.g., a real number). Each neuron can receive one or more signals as an input and output another signal by applying a non-linear function to the inputted signals. Neurons and edges can typically be weighted by corresponding weights to represent the “knowledge” the neural network has acquired. During a training process (similar to a learning process of a biological brain), the weights can be adjusted (e.g., by increasing or decreasing their values) to change the strengths of the signals between the neurons to improve the performance accuracy of the neural network. Neurons can apply a thresholding function (referred to as an “activation function”) to its output values of the non-linear function such that an signal is outputted only when an aggregated value (e.g., a weighted sum) of the output values of the non-linear function exceeds a threshold determined by the thresholding function. Different layers of neurons can transform their input signals in different manners (e.g., by applying different non-linear functions or activation functions). The output of the last layer (referred to as an “output layer”) can output the analysis result of the neural network, such as, for example, a categorization of the set of input data (e.g., as in image recognition cases), a numerical result, or any type of output data for obtaining an analytical result from the input data.

The “training” of the neural network, as used herein, can refer to a process of improving the accuracy of the output of the neural network. Typically, the training can be categorized into three types: “supervised training,” “unsupervised training,” and “reinforcement training.” In the supervised training, a set of target output data (also referred to as “labels” or “ground truth”) can be generated based on a set of input data using a method other than the neural network. The neural network can then be fed with the set of input data to generate a set of output data that is typically different from the target output data. Based on the difference between the output data and the target output data, the weights of the neural network can be adjusted in accordance with a rule. If such adjustments are successful, the neural network can generate another set of output data more similar to the target output data in a next iteration using the same input data. If such adjustments are not successful, the weights of the neural network can be adjusted again. After a sufficient number of iterations, the training process can be terminated in accordance with one or more predetermined criteria (e.g., the difference between the final output data and the target output data is below a predetermined threshold, or the number of iterations reaches a predetermined threshold). The trained neural network can be applied to analyze other input data.

In the unsupervised training, the neural network is trained without any external gauge (e.g., labels) to identify patterns in the input data rather than generating labels for them. Typically, the neural network can analyze shared attributes (e.g., similarities and differences) and relationships among the elements of the input data in accordance with one or more predetermined rules or algorithms (e.g., principal component analysis, clustering, anomaly detection, or latent variable identification). The trained neural network can extrapolate the identified relationships to other input data.

In the reinforcement learning, the neural network is trained without any external gauge (e.g., labels) in a trial-and-error manner to maximize benefits in decision making. The input data sets of the neural network can be different in the reinforcement training. For example, a reward value or a penalty value can be determined for the output of the neural network in accordance with one or more rules during training, and the weights of the neural network can be adjusted to maximize the reward values (or to minimize the penalty values). The trained neural network can apply its learned decision making knowledge to other input data.

It should be noted that the apparatus, systems and methods disclosed herein can be used in various neural network-based architectures, such as DNNs, convolutional neural networks (CNNs), recurrent neural networks (RNNs), or any architecture or algorithm that can cluster or label input data using machine perceptions (“artificial neurons” or “neurons”). The neural network-based architectures can be used for various applications, such as image classification, three-dimensional object recognition, machine translation, or transductive learning on graphs.

It should also be noted that the apparatus, systems and methods disclosed herein can also be configured for various architectures, such as a central processing unit (CPU), a graphics processing unit (GPU), a neural network processing unit (NPU), a field programmable gate array (FPGA), a tensor processing unit (TPU), a heterogeneous acceleration processing unit (HAPU), an application-specific integrated circuit (ASIC), or any circuit that is capable of processing data.

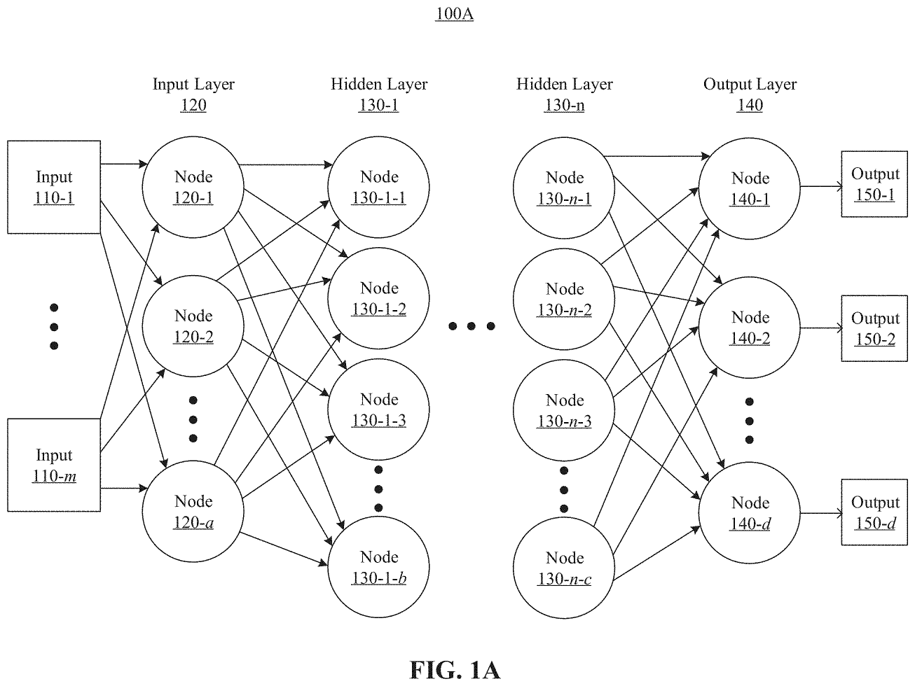

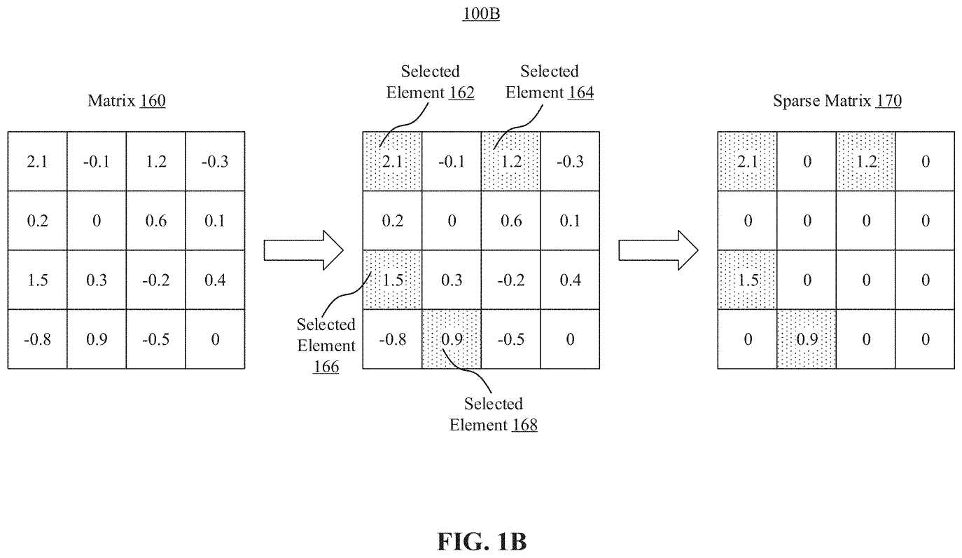

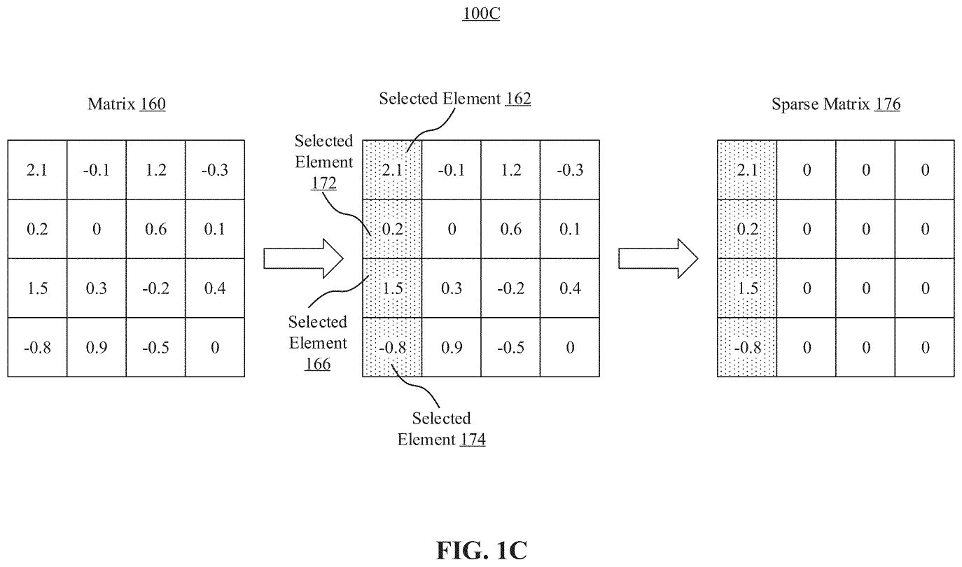

By way of example, FIG. 1A is a schematic representation of a neural network 100A. As depicted in FIG. 1A, neural network 100A can include an input layer 120 that receives inputs, including input 110-1, . . . , input 110-m (m being an integer). “Inputs” can include an image, text, or any other structure or unstructured data for processing by neural network 100A. In some embodiments, neural network 100A can receive a plurality of inputs simultaneously. For example, in FIG. 1A, neural network 100A can receive m inputs simultaneously. In some embodiments, input layer 120 can receive m inputs in succession such that input layer 120 receives input 110-1 in a first cycle (e.g., in a first inference) and pushes data from input 110-1 to a hidden layer (e.g., hidden layer 130-1), then receives a second input in a second cycle (e.g., in a second inference) and pushes data from input the second input to the hidden layer, and so on. Input layer 120 can receive any number of inputs in the simultaneous manner, the successive manner, or any manner of grouping the inputs.

Input layer 120 can include one or more nodes, including node 120-1, node 120-2, . . . , node 120-a (a being an integer). “Nodes” (“machine perceptions” or “neurons”) can model the functioning of a biological neuron. Each node can apply an activation function to received inputs (e.g., one or more of input 110-1, . . . , input 110-m). An activation function can include a Heaviside step function, a Gaussian function, a multiquadratic function, an inverse multiquadratic function, a sigmoidal function, a rectified linear unit (ReLU) function (e.g., a ReLU6 function or a Leaky ReLU function), a hyperbolic tangent (“tan h”) function, or any non-linear function. The output of the activation function can be weighted by a weight associated with the node. A weight can include a positive value between 0 and 1, or any numerical value that can scale outputs of some nodes in a layer more or less than outputs of other nodes in the same layer.

As further depicted in FIG. 1A, neural network 100A includes multiple hidden layers, including hidden layer 130-1, . . . , hidden layer 130-n (n being an integer). When neural network 100A includes more than one hidden layers, it can be referred to as a “deep neural network” (DNN). Each hidden layer can include one or more nodes. For example, in FIG. 1A, hidden layer 130-1 includes node 130-1-1, node 130-1-2, node 130-1-3, . . . , node 130-1-b (b being an integer), and hidden layer 130-n includes node 130-n-1, node 130-n-2, node 130-n-3, . . . , node 130-n-c (c being an integer). Similar to nodes of input layer 120, nodes of the hidden layers can apply the same or different activation functions to outputs from connected nodes of a previous layer, and weight the outputs from the activation functions by weights associated with the nodes.

As further depicted in FIG. 1A, neural network 100A can include an output layer 140 that finalizes outputs, including output 150-1, output 150-2, . . . , output 150-d (d being an integer). Output layer 140 can include one or more nodes, including node 140-1, node 140-2, . . . , node 140-d. Similar to nodes of input layer 120 and of the hidden layers, nodes of output layer 140 can apply activation functions to outputs from connected nodes of a previous layer and weight the outputs from the activation functions by weights associated with the nodes.

Although nodes of each hidden layer of neural network 100A are depicted in FIG. 1A to be connected to each node of its previous layer and next layer (referred to as “fully connected”), the layers of neural network 100A can use any connection scheme. For example, one or more layers (e.g., input layer 120, hidden layer 130-1, . . . , hidden layer 130-n, or output layer 140) of neural network 100A can be connected using a convolutional scheme, a sparsely connected scheme, or any connection scheme that uses fewer connections between one layer and a previous layer than the fully connected scheme as depicted in FIG. 1A.

Moreover, although the inputs and outputs of the layers of neural network 100A are depicted as propagating in a forward direction (e.g., being fed from input layer 120 to output layer 140, referred to as a “feedforward network”) in FIG. 1A, neural network 100A can additionally or alternatively use backpropagation (e.g., feeding data from output layer 140 towards input layer 120) for other purposes. For example, the backpropagation can be implemented by using long short-term memory nodes (LSTM). Accordingly, although neural network 100A is depicted similar to a convolutional neural network (CNN), neural network 100A can include a recurrent neural network (RNN) or any other neural network.

The “sparsifying” or “sparsification,” as used herein, can refer to decreasing the number of non-zero elements in a matrix. The resulting matrix of a sparsification operation can be referred to as a “sparse matrix” in this disclosure. In some embodiments, the sparsifying can further include quantizing (e.g., by rounding up to an integer) the remaining non-zero elements after the number of the non-zero elements of the matrix is decreased.

For example, neural network 100A in FIG. 1A can be sparsified for reducing consumption of computational and storage resources. For example, one or more matrices (e.g., a weight matrix, an activation matrix, or any matrix) associated with neural network 100A can be sparsified and represented as sparsity representations or formats (e.g., a CSR format, a CSC format, a DOK format, an LIL format, or a COO format). Typically, sparsification techniques (e.g., weight sparsity techniques) include irregular sparsification and structured sparsification.

The irregular sparsification (e.g., magnitude-based sparsification or generic sparsification) imposes no constraint on the locations of selected non-zero elements in a matrix. For example, the generic sparsification can zero all elements in a matrix that are not the N (N being any predetermined number, such as 4) largest elements in absolute value in the matrix. However, in some cases, the workload of generic sparsification can be irregular because positions of the non-zero elements can be anywhere in the matrix.

The structured sparsification (e.g., filter-wise, shape-wise, pattern, or kernel-wise sparsification, or unified sparsification) imposes one or more constraints on the locations of selected non-zero elements in a matrix for reducing irregularity. For example, the unified sparsification can zero all elements that are not within one or more selected spaces in the matrix based on level 1 (“L1”) or level 2 (“L2”) norm of the selected spaces. Different unified sparsification techniques can have different spatial constraints (e.g., a column-wise constraint, a row-wise constraint, a block-wise constraint, a filter-wise constraint, a channel-wise constraint, or any constraint related to a spatial character of the matrix). However, in some cases, the accuracy of an output of the unified sparsification can decrease significantly because some significant weights can be discarded due to being outside the selected spaces in the matrix.

By way of example, FIG. 1B is a schematic representation of an example sparsification 100B of an example matrix 160, consistent with some embodiments of this disclosure. Sparsification 100B can be generic sparsification. For example, matrix 160 can be a weight matrix associated with a neural network (e.g., neural network 100A in FIG. 1A). Sparsification 100B can reduce matrix 160 to a sparse matrix 170, and the neural network can use sparse matrix 170 in place of matrix 160 for reducing required computations. Although depicted as a 4×4 matrix in FIG. 1B, it should be noted that matrix 160 can be of any size.

As depicted in FIG. 1B, sparsification 100B can include an operation of selecting one or more non-zero elements (e.g., elements 162, 164, 166, and 168) from matrix 160. For example, elements 162, 164, 166, and 168 can be selected because they have the four largest absolute values in matrix 160. Although depicted as selecting four elements, it should be noted that sparsification 100B can select any predetermined number of elements in accordance with any predetermined rule. After selecting the elements, sparsification 100B can include an operation of zeroing non-selected elements, resulting a sparse matrix (e.g., sparse matrix 170). Accordingly, as depicted in FIG. 1B, sparsification 100B enforces 75% sparsity on matrix 160. The degree of sparsity of sparsification 100B can depend on the number of selected elements and the size of matrix 160.

By way of example, FIG. 1C is a schematic representation of another example sparsification 100C of matrix 160, consistent with some embodiments of this disclosure. Sparsification 100C can be unified sparsification. Sparsification 100C can reduce matrix 160 to a sparse matrix 176, and the neural network can use sparse matrix 176 in place of matrix 160 for reducing required computations.

As depicted in FIG. 1C, sparsification 100C can include an operation of selecting one or more non-zero elements (e.g., elements 162, 172, 166, and 174) from matrix 160. For example, elements 162, 172, 166, and 174 can be selected because they are within a selected column. Although depicted as selecting four elements, it should be noted that sparsification 100C can select any predetermined number of elements in accordance with any predetermined rule. Although depicted as selecting one column, it should be noted that sparsification 100C can select elements related to any number of any spatial character of the matrix, such as a column, a row, a block, a filter, a channel, a vector, or a combination thereof. After selecting the elements, sparsification 100C can include an operation of zeroing non-selected elements, resulting a sparse matrix (e.g., sparse matrix 176). Accordingly, as depicted in FIG. 1C, sparsification 100C enforces 75% sparsity on matrix 160. The degree of sparsity of sparsification 100C can depend on the number of selected elements and the size of matrix 160.

In some cases, sparsification 100B can face a challenge to provide spatial predictability in selecting elements that are not to be zeroed. For example, if sparsification 100B selects N (N being an integer) elements having the largest absolute values, those N elements can be unstructured (e.g., distributed randomly in matrix 160) in some cases, which can cause the software or hardware that implements sparsification 100B to deal with high-level randomness and to consume huge performance overhead. In another example, if matrix 160 is large, sparse matrix 170 can also be large, which can cause tracking multiplication of corresponding elements of sparse matrix 170 to consume significant memory resource. Sparsification 100C can provide spatial predictability in selecting elements that are not to be zeroed, because the non-zero elements are selected in a structured manner (e.g., elements of a column). However, in some cases, sparsification 100C can face a challenge to provide an acceptable accuracy level because some representative elements can be excluded from the selected column.

It should be noted that sparsification 100B and sparsification 100C are only examples of, rather than limitations to, generation of a sparse matrix, and sparse matrices 170 and 176 are only example sparse matrices. For example, the degree of sparsity can depend on a goal for the outcome, which can be a tradeoff between using more aggressive sparsification for a more accurate outcome versus using less aggressive sparsification for less consumption of computational resources. It should be noted that embodiments of this disclosure can use other sparsification techniques to generate sparse matrices with different degrees of sparsity and non-zero element distributions.

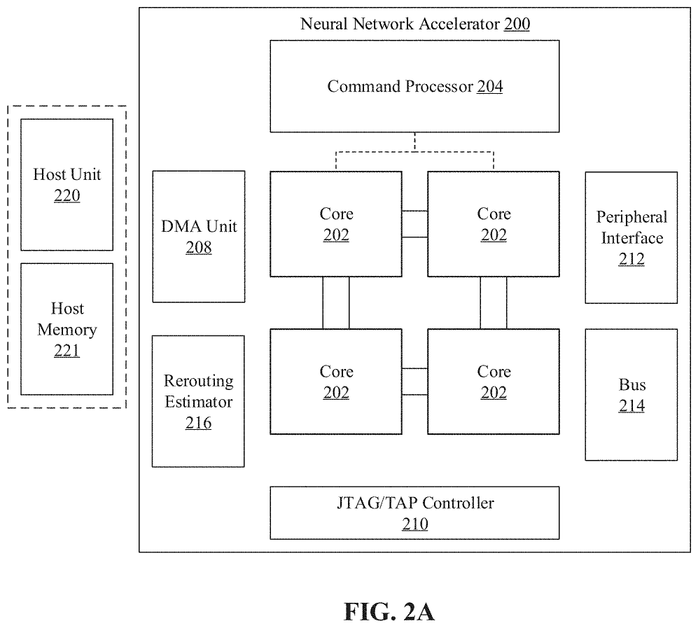

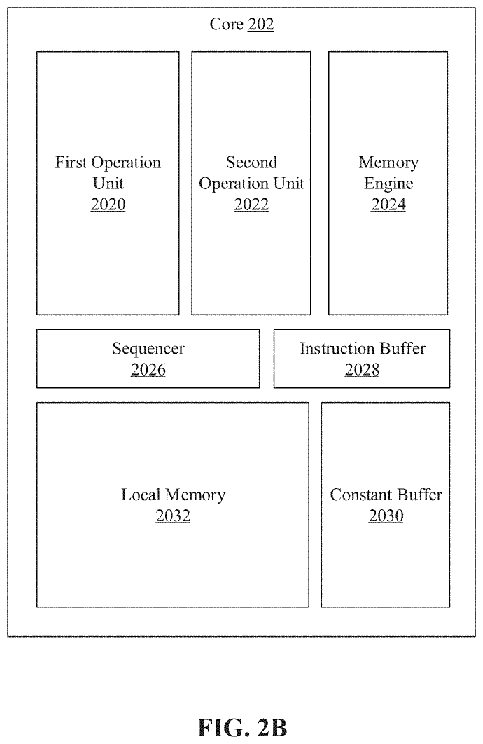

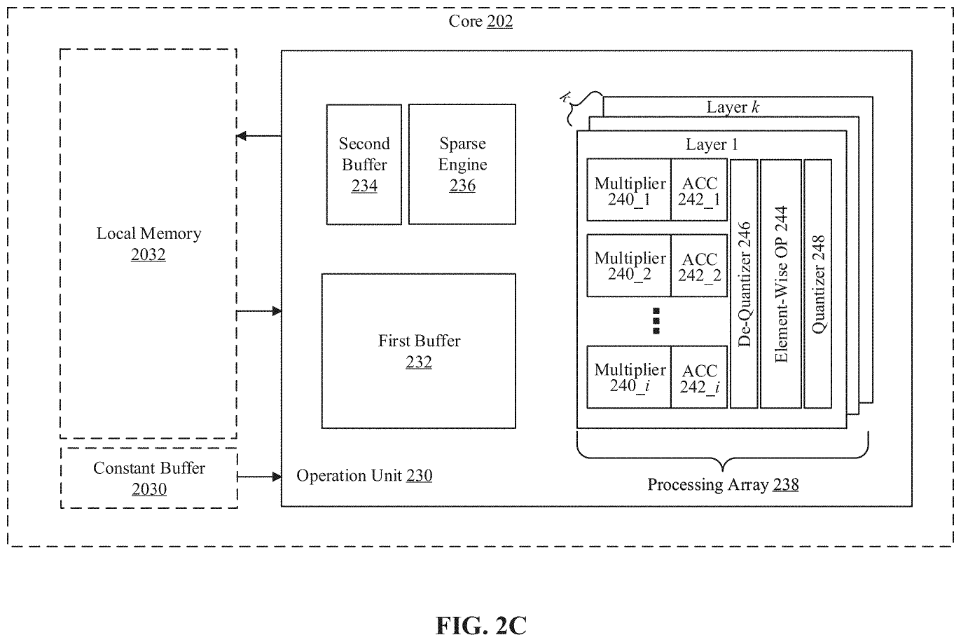

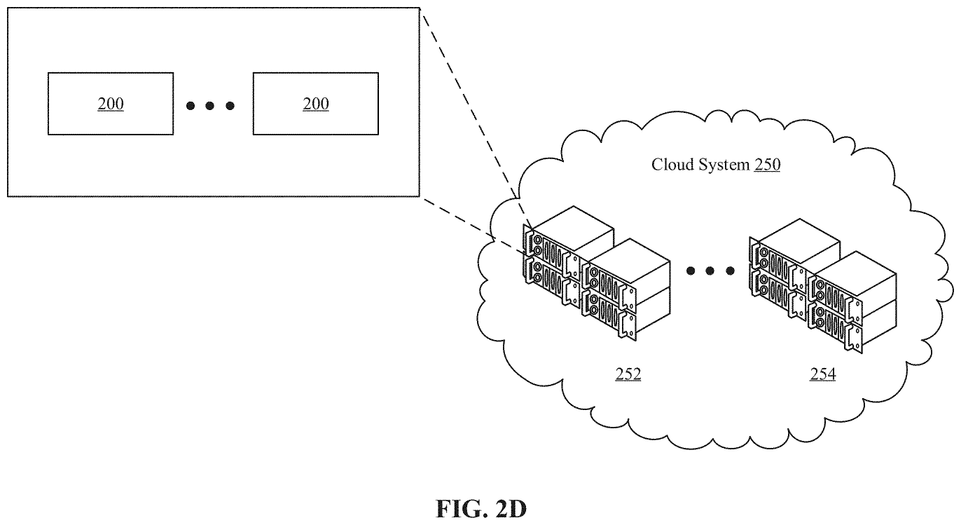

By way of example, FIGS. 2A-2D depict a neural network accelerator for sparsifying one or more matrices (e.g., a weight matrix, an activation matrix, or any matrix) associated with a neural network (e.g., neural network 100A in FIG. 1A). FIG. 2A illustrates an example configuration of neural network accelerator 200, consistent with some embodiments of this disclosure. In the context of this disclosure, a neural network accelerator can also be referred to as a machine learning accelerator or deep learning accelerator. In some embodiments, neural network accelerator 200 can be referred to as an NPU architecture 200. In some embodiments, neural network accelerator 200 can be an HAPU architecture. It should be noted that neural network accelerator 200 can be utilized in various neural networks (e.g., a CNN, a DNN, an RNN, or any other neural network). In addition, some embodiments can be configured for various processing architectures, such as an NPU, a GPU, an FPGA, a TPU, an ASIC, an HAPU, or any processing architecture that is capable of processing data.

As shown in FIG. 2A, neural network accelerator 200 can include one or more cores 202, a command processor 204, a direct memory access (DMA) unit 208, a Joint Test Action Group (JTAG)/Test Access End (TAP) controller 210, a peripheral interface 212, a bus 214, and an rerouting estimator 216. In some embodiments, neural network accelerator 200 can include one or more other components or elements (not shown in FIG. 2A). Although FIG. 2A shows four cores 202, it should be understood that neural network accelerator 200 can include a single core or any number of cores. As shown in FIG. 2A, Neural network accelerator 200 can interact with at least one of host unit 220 and host memory 221 that are outside thereof.

Cores 202 can perform algorithmic operations based on communicated data. Cores 202 can include one or more operation units for performing one or more operations (e.g., multiplication, addition, multiply-accumulate (MAC), or any number of any mathematical or algorithmic operations) based on a command (e.g., as a data packet) received from command processor 204. Command processor 204 can be communicatively coupled with one or more of cores 202 (e.g., as indicated by the dotted lines between command processor 204 and two of cores 202 in FIG. 2A). Each operation unit can include any number of processing units. For example, an operation unit can be of a single instruction, multiple data (SIMD) architecture that includes one or more processing units. To perform the operation on the communicated data, cores 202 can include an operation unit for processing information in the communicated data (e.g., in a form of data packets). In some embodiments, cores 202 can be communicatively coupled with each other (as indicated by the solid lines connecting each core in FIG. 2A). For example, cores 202 can be connected with a one-directional ring bus, which can support efficient pipelining for large neural network models. The architecture of cores 202 will be explained in detail associated with FIG. 2B.

Command processor 204 can interact with host unit 220 and host memory 221 to pass a command or data to one or more of core 202. For example, command processor 204 can receive the command from host unit 220 and receive the data from host memory 221. In another example, host unit 220 can store the command or data in host memory 221, and command processor 204 can receive the command and data from host memory 221. In some embodiments, command processor 204 can interact with host unit 220 under the supervision of a kernel mode driver (KMD). In some embodiments, command processor 204 can modify the command received from host unit 220 before sending it to cores 202, so that the command can enable cores 202 to work in parallel. For example, the modified command can be stored in an instruction buffer (e.g., instruction buffer 2028 in FIG. 2B or an instruction buffer outside cores 202). The instruction buffer can be integrated within or communicatively coupled to command processor 204 or a core (e.g., one of cores 202). In some embodiments, command processor 204 can coordinate one or more of cores 202 for parallel execution.

DMA unit 208 can assist with transferring data between host memory 221 and neural network accelerator 200. For example, DMA unit 208 can assist with loading the data from host memory 221 into one or more local memories (e.g., local memory 2032 in FIG. 2B) of corresponding cores 202. In some embodiments, DMA unit 208 can also assist with transferring data between multiple neural network accelerators (including neural network accelerator 200). DMA unit 208 can allow an off-chip device (not shown in FIG. 2A) to access on-chip and off-chip memories without causing an interrupt in a related processing unit (e.g., host unit 220 or command processor 204). In some embodiments, DMA unit 208 can assist with transferring data between components of neural network accelerator 200. For example, DMA unit 208 can assist with transferring data between multiple cores 202 or within each core. In some embodiments, DMA unit 208 can generate memory addresses and initiate memory read or write cycles. Additionally or alternatively, DMA unit 208 can include a register (e.g., a hardware register) that can be written and read by one or more processors (e.g., command processor 204 or cores 202), such as a memory address register, a byte-count register, a control register, or any number of any type of registers. The register can specify any combination of at least one of a source of the data to be transferred, a destination of the data to be transferred, a direction of the transfer (e.g., reading from an input/output or I/O device, or writing to the I/O device), a size of the transfer data, a number of bytes to transfer in one burst, or any feature of memory controllers. In some embodiments, neural network accelerator 200 can include one or more additional DMA units (not shown in FIG. 2A), which can transfer data between multiple neural network accelerators to allow them to communicate directly without involving a host processing unit (e.g., host unit 220 or command processor 204).

JTAG/TAP controller 210 can specify a debug port that implements a serial communications interface (e.g., a JTAG interface) for low-overhead access to neural network accelerator 200 without requiring direct external access to a system address or a data bus. In some embodiments, JTAG/TAP controller 210 can include an on-chip test access interface (e.g., a TAP interface) that implements a protocol for accessing a set of test registers that present chip logic levels and device capabilities of various parts.

Peripheral interface 212 (e.g., a PCIe interface) can serve as an inter-chip bus for providing communication between neural network accelerator 200 and other devices (not shown in FIG. 2A). Bus 214 (e.g., an inter-integrated circuit or “I²C” bus) can include at least one of an intra-chip bus or an inter-chip bus. The intra-chip bus can connect internal components, which can allow the internal components to be called for as a single unit by neural network accelerator 200. While not all components are connected to each other by the intra-chip bus, all components do have some connection to other components they need to communicate with. The inter-chip bus can connect neural network accelerator 200 with another device (not shown in FIG. 2A), such as an off-chip memory or a peripheral device. For example, bus 214 can provide high speed communication across cores 202 and can also connect cores 202 with other units (e.g., the off-chip memory or the peripheral device). In some embodiments, bus 214 can include only one or more intra-chip buses, while peripheral interface 212 can include only one or more inter-chip bus. In some embodiments, while peripheral interface 212 can include one or more inter-chip bus, bus 214 can also include an inter-chip bus in addition to one or more intra-chip buses.

Rerouting estimator 216 can determine an inference status (e.g., a predicted inference latency or a predicted processor utilization rate) of a neural network (e.g., neural network 100A in FIG. 1A) based on data related to a runtime environment (referred to as “environment data”) or data related to a predetermined condition (e.g., received via an API, referred to as “user data”), when neural network accelerator 200 performs an inference operation. In some embodiments, rerouting estimator 216 can receive and store the environment data or the user data (e.g., via peripheral interface 212 or bus 214) for determining the inference status, and command processor 204 can determine a sparsity level (e.g., a sparsity level of a weight matrix) of the neural network to be used for the inference operation based on the inference status. The environment data can include data representative of an external runtime condition or an internal runtime condition. For example, the environment data can include a power consumption rate (e.g., of cores 202 or host unit 220), a processing throughput (e.g., of cores 202, DMA unit 208, or host unit 220), a processor utilization rate or processor frequency (e.g., of cores 202, command processor 204, or host unit 220), a temperature (e.g., of cores 202, command processor 204, or any component of neural network accelerator 200), a battery power level (e.g., of a device incorporating neural network accelerator 200), or any parameter related to the runtime environment of a device (e.g., a smartphone) incorporating the neural network accelerator 200. In some embodiments, the environment data can be detected by one or more sensors of the device or obtained via one or more APIs of the device. Rerouting estimator 216 can be implemented as hardware (e.g., a circuit). In some embodiments, rerouting estimator 216 can be integrated with command processor 204 as a single component. In some embodiments, rerouting estimator 216 can be implemented as software (e.g., an API or a set of instructions) stored inside or outside neural network accelerator 200, which can be executed by command processor 204.

Host unit 220 can communicate with neural network accelerator 200 and can include one or more processing units (e.g., an X86 CPU). As shown in FIG. 2A, host unit 220 can be communicatively coupled to host memory 221. Host memory 221 can store a large amount of data with slower access speed compared with an on-chip memory (e.g., a cache) integrated within host unit 220. In some embodiments, the data stored in host memory 221 can be transferred to neural network accelerator 200 to be used for executing neural network models. In some embodiments, host memory 221 can be an internal memory (e.g., a random-access memory or RAM) or an external memory (e.g., a host disk) associated with host unit 220. For example, host memory 221 can include a double data rate synchronous dynamic RAM (“DDR SDRAM”). In another example, host memory 221 can include a host disk for providing additional memory for host unit 220.

In some embodiments, a host system that includes host unit 220 and host memory 221 can include a compiler (not shown in FIG. 2A). The compiler can be a program or computer software that transforms computer codes written in a programming language into instructions for neural network accelerator 200 to create an executable program. For example, in machine learning applications, a compiler can perform a variety of operations, such as pre-processing, lexical analysis, parsing, semantic analysis, conversion of input programs to an intermediate representation, initialization of a neural network, code optimization, and code generation, or any combination thereof. In some embodiments, the compiler can compile a neural network to generate a static parameter (e.g., a connection among neurons or a weight of a neuron).

In some embodiments, the host system (not shown in FIG. 2A) including the compiler can push one or more commands to neural network accelerator 200. As described above, in some embodiments, these commands can be processed by command processor 204, temporarily stored in an instruction buffer (e.g., instruction buffer 2028 in FIG. 2B) of neural network accelerator 200, and distributed to one or more of cores 202 or other processing elements (e.g., DMA unit 208, JTAG/TAP controller 210, peripheral interface 212, or bus 214). For example, some of the commands can instruct DMA unit 208 to load instructions or data from host memory 221 into neural network accelerator 200. The loaded instructions can then be distributed to one or more of cores 202 for processing.

In some embodiments, the first few instructions received by a core (e.g., one of cores 202) can instruct it to load or store data from host memory 221 into its local memory. The core can then initiate an instruction pipeline for fetching an instruction (e.g., via sequencer 2026 in FIG. 2B) from an instruction buffer (e.g., instruction buffer 2028 in FIG. 2B), decoding the instruction (e.g., via DMA unit 208), generating one or more local memory addresses (e.g., corresponding to an operand), reading source data, performing executing, loading, or storing operations, and then writing results back (e.g., to host memory 221 via DMA unit 208).

In some embodiments, neural network accelerator 200 can further include a global memory (not shown in FIG. 2A) that includes one or more memory blocks (e.g., four blocks of 8 GB second generation of high bandwidth memory or “HBM2”) to serve as a main memory. In some embodiments, the global memory can fetch and store instructions and data from host memory 221 via DMA unit 208. The instructions can then be distributed to an instruction buffer associated with a core (e.g., one of cores 202) assigned with a corresponding task, and the core can process these instructions accordingly.

In some embodiments, neural network accelerator 200 can further include a memory controller (not shown in FIG. 2A) for managing reading and writing of data to and from a memory block (e.g., an HBM2) within the global memory. For example, the memory controller can manage reading or writing data from cores 202 (e.g., from local memory 2032 in FIG. 2B) or from a core of another accelerator (e.g., via DMA unit 208 or a DMA unit of the other accelerator). In some embodiments, neural network accelerator 200 can include multiple memory controllers. For example, each memory block (e.g., HBM2) within the global memory can include a corresponding memory controller.

In some embodiments, the memory controller can generate a memory address and initiate a memory reading or writing cycle. The memory controller can contain a register (e.g., a hardware register) that can be written and read by neural network accelerator 200. The registers can include a memory address register, a byte-count register, a control register, or any number of any other type of registers. The register can specify any combination of at least one of a source of the data to be transferred, a destination of the data to be transferred, a direction of the transfer (e.g., reading from an input/output or I/O device, or writing to the I/O device), a size of the transfer data, a number of bytes to transfer in one burst, or any feature of memory controllers.

It should be noted that neural network accelerator 200 can be deployed to computing devices in other forms, not limited to the examples described in this disclosure. Additionally, or alternatively, in some embodiments, neural network accelerator 200 can also provide ability to perform parallel computation.

By way of example, FIG. 2B is a schematic representation of an example configuration of a core 202 of a neural network accelerator (e.g., neural network accelerator 200 of FIG. 2A), consistent with some embodiments of this disclosure. As shown in FIG. 2B, core 202 can include one or more operation units (including first and second operation units 2020 and 2022), a memory engine 2024, a sequencer 2026, an instruction buffer 2028, a constant buffer 2030, and a local memory 2032. In some embodiments, core 202 can include one or more other components or elements (not shown in FIG. 2B).

First and second operation units 2020 and 2022 can perform the same or different operations. In some embodiments, first operation unit 2020 can include one or more processing units for performing one or more operations (e.g., multiplication, addition, MAC, matrix-element-wise operation, matrix-element-wise operation, or any number of any mathematical or algorithmic operations) on received data (e.g., a matrix). In some embodiments, first operation unit 2020 can accelerate execution of convolution operations or matrix multiplication operations. In some embodiments, second operation unit 2022 can perform a pooling operation, an interpolation operation, a region-of-interest (ROI) identification operation, or any number of any mathematical or algorithmic operations. In some embodiments, second operation unit 2022 can include an interpolation unit, a pooling data path, or any circuit for performing any mathematical or algorithmic operation.

Memory engine 2024 can copy data within core 202 or between two cores (e.g., any two of cores 202 in FIG. 2A). In some embodiments, a DMA unit (e.g., DMA unit 208 in FIG. 2A) can assist with the data copying. For example, the DMA unit can assist memory engine 2024 to copy data from local memory 2032 into an operation unit (e.g., first operation unit 2020 or second operation unit 2022). In some embodiments, matrix transposition can also be performed in memory engine 2024 to make the matrix suitable to be used in the operation unit.

Sequencer 2026 can be communicatively coupled to instruction buffer 2028 for receiving and distributing commands to components of core 202. For example, sequencer 2026 can distribute a convolution command or a multiplication command to first operation unit 2020, distribute a pooling command to second operation unit 2022, and distribute a data-copy command to memory engine 2024. In some embodiments, sequencer 2026 can monitor execution of a neural network task and parallelize sub-tasks of the neural network task to improve execution efficiency. In some embodiments, first operation unit 2020, second operation unit 2022, and memory engine 2024 can run in parallel under control of sequencer 2026 according to instructions stored in instruction buffer 2028.

Instruction buffer 2028 can store one or more instructions associated with core 202. In some embodiments, instruction buffer 2028 is communicatively coupled to sequencer 2026 for providing instructions thereto. In some embodiments, instructions stored in instruction buffer 2028 can be transferred or modified by a command processor (e.g., command processor 204 in FIG. 2A).

Constant buffer 2030 can store one or more constant values. In some embodiments, constant values stored in constant buffer 2030 can be used by an operation unit (e.g., first operation unit 2020 or second operation unit 2022) for batch normalization, quantization, de-quantization, or any mathematical or algorithmic operation.

Local memory 2032 can provide storage space for boosting reading/writing speed. In some embodiments, local memory 2032 can have a large storage space (e.g., at least 192 MB) for reducing interactions with a global memory (not shown in FIG. 2B). With the large storage space, most of data access can be performed within core 202 to reduce latency. In some embodiments, to minimize data loading latency and energy consumption, local memory 2032 can integrate an on-chip static random access memory (SRAM). In some embodiments, local memory 2032 be evenly distributed on core 202 to mitigate dense wiring and heating issues.

By way of example, FIG. 2C is a schematic representation of an example configuration of an operation unit 230 of a core (e.g., core 202 in FIG. 2B) of a neural network accelerator (e.g., neural network accelerator 200 in FIG. 2A), consistent with some embodiments of this disclosure. In some embodiments, operation unit 230 can be first operation unit 2020 or second operation unit 2022 in FIG. 2B. As depicted in FIG. 2C, operation unit 230 includes a first buffer 232, a second buffer 234, a sparse engine 236, and a processing array 238. In some embodiments, operation unit 230 can include one or more other components or elements (not shown in FIG. 2C).

First buffer 232 can store input data (e.g., activation data for a convolution operation) to be used by processing array 238. In some embodiments, operation unit 230 can receive the input data from local memory 2032 and store the input data in first buffer 232. In some embodiments, operation unit 230 can reuse or share data stored in first buffer 232 for processing array 238 to use.

Second buffer 234 can store matrix data, such as a representation (e.g., a CSR format, a CSC format, a DOK format, an LIL format, or a COO format) of a sparse matrix (e.g. sparse matrix 170 or 176 in FIGS. 1B-1C). For example, operation unit 230 can receive the representation through a memory engine (e.g., memory engine 2024 in FIG. 2B) from local memory 2032, and store the representation in second buffer 234. In some embodiments, second buffer 234 can be a part of or separate from first buffer 232. First buffer 232 and second buffer 234 can be any suitable memory that provides data storage space, such as a register, a DRAM, a SRAM, or any device for storing data for immediate use by a computer hardware component (e.g., operation unit 230).

Sparse engine 236 can be communicatively coupled to second buffer 234 for reading data from or writing data to second buffer 234. In some embodiments, sparse engine 236 can include one or more decompressors (e.g., circuits, not shown in FIG. 2C) for decompressing the representation stored in second buffer 234. For example, sparse engine 236 can read and decompress a representation of a sparse matrix (e.g. sparse matrix 170 or 176 in FIGS. 1B-1C) associated with a neural network (e.g., neural network 100A in FIG. 1A) from second buffer 234 to obtain the sparse matrix.

Processing array 238 can receive the decompressed sparse matrix from sparse engine 236 and perform an operation (e.g., addition, multiplication, MAC, convolution, or any mathematical or algorithmic operation) on the decompressed sparse matrix. In some embodiments, processing array 238 can receive input data from first buffer 232 and use them in the operation. Processing array 238 can include k layers (k being any number), each layer including i processing strings (i being any number) for performing computations. In some embodiments, the processing strings can be performed in parallel. For example, layer 1 of processing array 238 can include i processing strings, in which a first processing string includes a multiplier 240_1 (e.g., for calculating a dot product) and an accumulator (ACC) 242_1, a second processing string includes a multiplier 240_2 and an ACC 242_2, and so on. In some embodiments, processing array 238 can perform computations under SIMD control. For example, when performing a convolution operation, each layer of processing array 238 can execute the same instructions with different data.

In some embodiments, when the number of processing strings (i.e., i) in one layer (e.g., layer 1) of processing array 238 is smaller than a number (e.g., b, which can be any number) of work items to be processed, processing array 238 can process i number of work items in a first stage, and process the remaining work items (e.g., b−i number of work items if b<2i) in a subsequent stage. In some embodiments, after the first stage, another processing array in another core can process the remaining work items in the subsequent stage.

Each layer of processing array 238 can further include an element-wise operation processor (OP) 244, a de-quantizer 246, and a quantizer 248. Element-wise operation processor 244 can sequentially perform an element-wise operation (e.g., an activation function) on output values of accumulators (e.g., ACC 242_1, 242_2, . . . , and 242_i). For example, the activation function can include a Heaviside step function, a Gaussian function, a multiquadratic function, an inverse multiquadratic function, a sigmoidal function, a rectified linear unit (ReLU) function (e.g., a ReLU6 function or a Leaky ReLU function), a hyperbolic tangent (“tan h”) function, or any non-linear function. In some embodiments, element-wise operation processor 244 can be positioned at the end of the i processing strings of a layer (e.g., layer 1) of processing array 238. In some embodiments, the i processing strings in the layer can share the same element-wise operation processor 244. In some embodiments, element-wise operation processor 244 can process a data type different from a data type processed by a multiplier (e.g., multiplier 240_1, 240_2, or 240_i) or an accumulator (e.g., ACC 242_1, 242_2, or 242_i). For example, the multiplier or accumulator can perform operations on integer-type data (e.g., Int_8 or Int_16), and element-wise operation processor 244 can perform on floating-point-type data (e.g., FP24).

When element-wise operation processor 244 processes a data type different from a data type processed by the multiplier or accumulator, de-quantizer 246 and quantizer 248 can convert the different data types for processing. For example, element-wise operation processor 244 can be arranged between de-quantizer 246 and quantizer 248 as shown in FIG. 2C. In some embodiments, de-quantizer 246 can additionally perform a batch normalization operation because both de-quantization and batch normalization can be performed by multiplication operations and addition operations with constants. The constants can be provided from constant buffer 2030. In some embodiments, a compiler (e.g., the compiler as described in association with FIG. 2A) can merge batch normalization and de-quantization into a single operation.

The neural network accelerator disclosed herein (e.g., neural network accelerator 200 in FIG. 2A) can be integrated in a computing device (e.g., a smart phone, a tablet, a wearable device, or a computing server). By way of example, FIG. 2D is a schematic representation of an example cloud system 250 that includes a neural network accelerator, consistent with some embodiments of this disclosure. As shown in FIG. 2D, cloud system 250 can provide a cloud service with artificial intelligence (AI) capabilities and can include one or more computing servers (including computing servers 252 and 254). In some embodiments, a computing server 252 can incorporate one or more neural network accelerators (e.g., neural network accelerator 200 of FIG. 2A). For simplicity and clarity, neural network accelerator 200 is shown in FIG. 2D in a simplified manner. With the assistance of neural network accelerator 200, cloud system 250 can provide the AI capabilities of, for example, image recognition, facial recognition, translations, 3D modeling, or any task that can simulate or correspond to high-level human-intelligence actions.

Consistent with some embodiments of this disclosure, a method for providing a neural network with multiple sparsity levels can include sparsifying a matrix associated with the neural network to form a first sparse matrix. In some embodiments, the matrix can be sparsified by applying an alternating direction method of multipliers (ADMM) to the matrix. By way of example, the matrix can be matrix 160 in FIGS. 1B-1C. The first sparse matrix can be matrices 170 or 176 in FIGS. 1B-1C. The sparsification can be implemented as irregular sparsification (e.g., sparsification 100B in FIG. 1B) or structured sparsification (e.g., sparsification 100C in FIG. 1B).

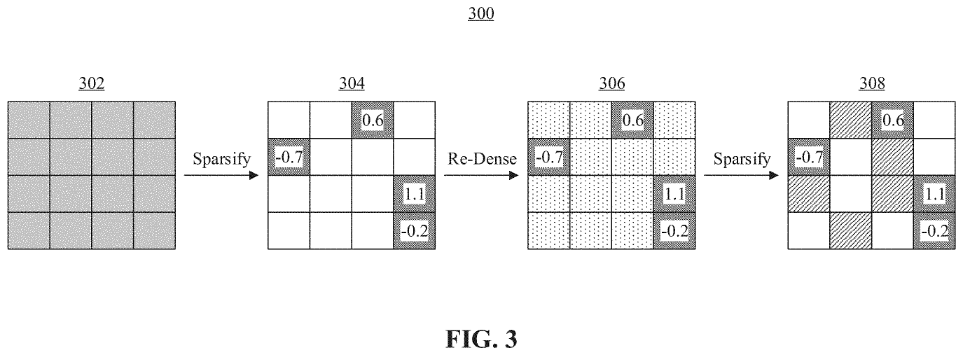

By way of example, FIG. 3 is a schematic representation of an example process 300 of sparsifying and re-densing a matrix of a multi-level sparse neural network, consistent with some embodiments of this disclosure. The “re-densing,” as used herein, can refer to increasing the number of non-zero elements in a sparse matrix. As an example, a matrix 302 in FIG. 3 can be the first matrix, and a first sparse matrix 304 in FIG. 3 can be the first sparse matrix.

Process 300 shows operations performed on an example 4×4 matrix 302 (represented by 4×4 boxes) associated with a layer of a neural network (e.g., neural network 100A in FIG. 1A). For example, matrix 302 can be an activation matrix or a weight matrix. In FIG. 3, each box of matrix 302 is gray, which represents that each element of matrix 302 is non-zero.

Process 300 can sparsify (e.g., by applying sparsification 100B in FIG. 1B or sparsification 100C in FIG. 1C) matrix 302 to first sparse matrix 304 with a first sparsity level. In some embodiments, an alternating direction method of multipliers (ADMM) can be used to sparsify matrix 302 irregularly for achieving higher accuracy. In FIG. 3, first sparse matrix 304 includes white boxes that represent zero values and dense-dotted boxes that represent non-zero values (i.e., 0.6, −0.7, 1.1, and −0.2). In this case, the first sparsity level of first sparse matrix 304 is 75%.

Process 300 can train the neural network using first sparse matrix 304 to form (“re-dense”) dense matrix 306. In some embodiments, dense matrix 306 can be formed from matrix 302 via first sparse matrix 304 using a dense-sparse-dense (“DSD”) method, by which accuracy of matrix 302 can be improved. During the training of the neural network, values and locations of non-zero elements of first sparse matrix 304 are fixed or unchanged, and one or more zero-value elements of first sparse matrix 304 can be updated with possibilities to become non-zero values after the training. The training can be optimized towards improving performance and accuracy of first sparse matrix 304. In some embodiments, hyper parameters (e.g., a dropout ratio or a weight decay) of first sparse matrix 304 can remain unchanged while applying the DSD method. As depicted in FIG. 3, the values and locations of the non-zero elements of first sparse matrix 304 (i.e., 0.6, −0.7, 1.1, and −0.2) are the same in dense matrix 306 (represented by the dense-dotted boxes), and the zero-value elements of first sparse matrix 304 (represented by the white boxes) are updated to be non-zero values (represented by the sparse-dotted boxes). By re-densing first sparse matrix 304 to dense matrix 306, model capacity of the neural network can increase. In some cases, dense matrix 306 can have even higher accuracy than matrix 302.

In some embodiments, as not depicted in FIG. 3, second sparse matrix 308 can be directly generated from first sparse matrix 304 without using the DSD method. It should be noted that any method can be used for generating second sparse matrix 308 based on first sparse matrix 304, and this disclosure does not limit those methods to the above-described examples.

After generating dense matrix 306, process 300 can sparsify (e.g., by applying sparsification 100B in FIG. 1B or sparsification 100C in FIG. 1C) it to second sparse matrix 308 with a second sparsity level. During the sparsification, the values and the locations of the non-zero elements of first sparse matrix 304 are fixed or unchanged. In some embodiments, an ADMM can be used to sparsify dense matrix 306 for achieving higher accuracy. As depicted in FIG. 3, the values and locations of the non-zero elements of first sparse matrix 304 (i.e., 0.6, −0.7, 1.1, and −0.2) are the same in second sparse matrix 308 (represented by the dense-dotted boxes). Second sparse matrix 308 further includes white boxes that represent zero values and shaded boxes that represent additional non-zero values. It can be seen that the non-zero values of second sparse matrix 308 are a superset of the non-zero values of first sparse matrix 304. In such a case, the second sparsity level of second sparse matrix 308 is 43.75%.

Second sparse matrix 308 can be outputted for executing the layer of the neural network. As depicted in FIG. 3, second sparse matrix 308 can encode information of both first sparse matrix 304 and itself in a hierarchical structure by fixing the values and locations of the non-zero elements of first sparse matrix 304 throughout process 300 once they are determined. Based on a predetermined condition, first sparse matrix 304 or second sparse matrix 308 can be dynamically selected for inference.

Consistent with some embodiments of this disclosure, the method for providing a neural network with multiple sparsity levels can also include training the neural network using the first sparse matrix to form a second sparse matrix by fixing values and locations of non-zero elements of the first sparse matrix and updating a zero-value element of the first sparse matrix to be a non-zero value. Non-zero elements of the second sparse matrix can include the non-zero elements of the first sparse matrix. The first sparse matrix and the second sparse matrix can be different matrices. The “fixing,” as used herein, can refer to an operation of keeping locations (e.g., coordinates or indices) and values of one or more elements of a matrix unchanged. Non-zero elements of the second sparse matrix can include the non-zero elements of the first sparse matrix. That is, the non-zero elements of the second sparse matrix can be a superset of the non-zero elements of the first sparse matrix. In some embodiments, the neural network can be trained using supervised training.

By way of example, the second sparse matrix can be second sparse matrix 308 in FIG. 3. The non-zero elements of the first sparse matrix can be the elements of 0.6, −0.7, 1.1, and −0.2 of first sparse matrix 304 in FIG. 3. The non-zero value updated from the zero-value element of the first sparse matrix can be represented by a shaded box in second sparse matrix 308 in FIG. 3. As depicted by the examples in FIG. 3, the elements of 0.6, −0.7, 1.1, and −0.2 can have the same locations in first sparse matrix 304 and second sparse matrix 308.

In some embodiments, the first sparse matrix can be directly re-densed to form the second sparse matrix, such as by using a dense-sparse-dense (“DSD”) method. For example, forming the second sparse matrix using the first matrix can include training the neural network using the first sparse matrix to form a third matrix by fixing the values and the locations of the non-zero elements of the first sparse matrix and updating a zero-value element of the first sparse matrix to be a non-zero value, and sparsifying the third matrix to form the second sparse matrix. The non-zero elements of the first sparse matrix can have the same locations in the first sparse matrix, in the third matrix, and in the second sparse matrix. In some embodiments, the third matrix can be sparsified to form the second sparse matrix by applying an ADMM to the third matrix.

In some cases, the first sparse matrix can be too sparse and cause the training of the neural network to update a large number of zero-value elements (e.g. during backpropagation). For example, if an entire kernel of a convolutional layer is pruned, or if an entire row of a weight matrix is pruned, the processor cannot update the zero-value elements effectively if not setting them as random numbers first. In some embodiments, to effectively train the neural network, forming the second sparse matrix using the first matrix can include setting the zero-value element of the first sparse matrix to be a random number, and training the neural network using the first sparse matrix including the random number.

Consistent with some embodiments of this disclosure, the method for providing a neural network with multiple sparsity levels can further include outputting the second sparse matrix for executing the neural network. In some embodiments, outputting the second sparse matrix can include encoding the second sparse matrix to be a sparse-matrix representation based on a compressed sparse row (CSR), a compressed sparse column (CSC), a dictionary of keys (DOK), a list of list (LIL), or a coordinate list (COO), and outputting the sparse-matrix representation for executing the neural network.

In some embodiments, the sparse-matrix representation can be based on the CSR and include a first array, a second array, a third array, and a fourth array. The first array can include the non-zero elements of the second sparse matrix in a row-by-row order (e.g., from top to bottom) of the second sparse matrix. Any element in a row of the second sparse matrix and belonging to the non-zero elements of the first sparse matrix can lead, in the first array, all elements in the row and not belonging to the non-zero elements of the first sparse matrix. The second array can include column indices in the second sparse matrix corresponding to respective array elements of the first array. The third array can include a first set of array indices in the first array, and array elements of the first array corresponding to the first set of array indices can include starting non-zero elements of each row of the second sparse matrix represented in the first array. The fourth array can include a second set of array indices in the first array, and array elements of the first array corresponding to the second set of array indices can include trailing non-zero elements in each row of the first sparse matrix.

The sparse-matrix representation can be illustrated by the following examples. For example, the first sparse matrix and the second sparse matrix in method 600 can be two 4×8 matrices M1 and M2 represented by Eq. (1) and Eq. (2), respectively, as follows:

$$\begin{matrix}M 1 = [ \begin{matrix}0 & 1 & 0 & 0 & 0 & 0 & 0 & 0 \\ 0 & 0 & 0 & 8 & 0 & 0 & 7 & 0 \\ 0 & 0 & 3 & 0 & 0 & 0 & 0 & 0 \\ 0 & 0 & 0 & 0 & 0 & 0 & 6 & 0\end{matrix} ] & Eq . ( 1 ) \\ M 2 = [ \begin{matrix}0 & 1 & 0 & 0 & 0 & 0 & 0 & 0 \\ 2 & 0 & 0 & 8 & 0 & 0 & 7 & 0 \\ 0 & 0 & 3 & 0 & 0 & 5 & 0 & 0 \\ 0 & 0 & 0 & 0 & 9 & 0 & 6 & 4\end{matrix} ] & Eq . ( 2 )\end{matrix}$$

As shown in Eqs. (1) and (2), the non-zero elements in M1 have the same values and locations in M2. The first array A1 of the sparse-matrix representation for M2 can be represented by Eq. (3):

A1=[1 8 7 2 3 5 6 9 4] Eq. (3)

Eq. (3) shows that A1 includes all the non-zero elements of M2 in a row-by-row order. If rewriting A1 as [(1) (8 7 2) (3 5) (6 9 4)] where numbers in each parenthesis pair represent elements of a row in M2, it shows that the non-zero elements of M2 in the first row (i.e., 1), in the second row (i.e., 2, 8, and 7), in the third row (i.e., 3 and 5), and in the fourth row (i.e., 9, 6, and 4) are arranged in the row-by-row order in A1, although the order (e.g., from left to right) of the non-zero elements within each row of M2 is not kept in A1.

Further, in A1, any element in a row of M2 and belonging to the non-zero elements of M1 can lead all elements in the row and not belonging to the non-zero elements of M1. For example, the second row of M2 includes “8” and “7” that belong to M1 and “9” that does not belong to M1. Accordingly, “8” and “7” lead “9” in A1. As another example, the fourth row of M2 includes “6” that belongs to M1 and “9” and “4” that do not belong to M1. Accordingly, “6” leads “9” and “4” in A1.

The second array A2 of the sparse-matrix representation for M2 can be represented by Eq. (4):

A2=[1 3 6 0 2 5 6 4 7] Eq. (4)

Eq. (4) shows that A2 includes column indices in M2 corresponding to respective array elements of A1. That is, A2[i] is a column index in M2 corresponding to A1[i] for i being a number starting from 0. For example, A1[0]=1 that corresponds to a column index A2[0]=1 in M2, A1[1]=8 that corresponds to a column index A2[1]=3 in M2, A1[2]=7 that corresponds to a column index A2[2]=6 in M2, and so on. It can be seen that the length of A1 is equal to the length of A2, both being equal to the total number of non-zero elements in M2.

The third array A3 of the sparse-matrix representation for M2 can be represented by Eq. (5):

A3=[0 1 4 6 9] Eq. (5)

Eq. (5) shows that A3 includes a first set of array indices in A1, and array elements of A1 corresponding to the first set of array indices include starting non-zero elements of each row of M2 represented in A1. That is, A3[i] is an index in A1, and A1[A3[i]] is the starting non-zero element in row i of M2 represented in A1 for i being a number starting from 0. For example, rewriting A1 as [(1) (8 7 2) (3 5) (6 9 4)] where numbers in each parenthesis pair represent elements of a row in M2, it can be seen that A3[1]=1, that row 1 of M2 represented in A1 is “(8 7 2),” and that A1[A3[1]]=8 is the starting non-zero element of “(8 7 2).” As another example, it can be seen that A3[3]=6, that row 3 of M2 represented in A1 is “(6 9 4),” and that A1[A3[3]]=6 is the starting non-zero element of “(6 9 4).” Also, Eq. (5) shows that A3 includes an extra element “9” that represents the total number of non-zero elements of A1.

Eq. (5) also shows that, rows of M2 represented in A1 can be decoded from A1 and A3. That is, A1[A3[i]] is the starting non-zero element in row i of M2 represented in A1, and A1[A3[i+1]−1] is the trailing non-zero element in row i of M2 represented in A1. Similarly, column indices of elements of the rows of M2 can be decoded from A2 and A3, by which M2 can be fully reconstructed. That is, A2[A3[i]] is the column index of the starting non-zero element in row i of M2 represented in A1, and A2[A3[i+1]−1] is the column index of the trailing non-zero element in row i of M2 represented in A1. For example, rewriting A1 as [(1) (8 7 2) (3 5) (6 9 4)] and A2 as [(1) (3 6 0) (2 5) (6 4 7)] where numbers in each parenthesis pair corresponds to a row in M2, it can be seen that A3[2]=4, that row 2 of M2 represented in A1 is “(3 5),” that A1[A3[2]]=3 is the starting non-zero element of “(3 5),” that A2[A3[2]]=2 is the column index of the starting non-zero element of “(3 5),” that A3[2+1]=A3[3]=6, A1[A3[2+1]-1]=5 is the trailing non-zero element of “(3 5),” and that A2[A3[2+1]-1]=5 is the column index of the trailing non-zero element of “(3 5).” M1 can be fully reconstructed after decoding the rows of M1 and each column index of the elements in the rows using A1, A2, and A3.

The fourth array A4 of the sparse-matrix representation for M2 can be represented by Eq. (6):

A4=[1 3 5 7] Eq. (6)

Eq. (6) shows that A4 includes a second set of array indices in A1, and array elements of A1 corresponding to the second set of array indices include trailing non-zero elements in each row of M1. That is, A4[i] is an index in A1, and A1[A4[i]−1] is the trailing non-zero element in row i of M1 for i being a number starting from 0. For example, rewriting A1 as [(1) (8 7 2) (3 5) (6 9 4)] where numbers in each parenthesis pair represent elements of a row in M2, it can be seen that A4[1]=3, that row 1 of M1 is “(8 7),” and that A1[A4[1]−1]=7 is the trailing non-zero element of “(8 7).” As another example, it can be seen that A4[3]=7, that row 3 of M1 represented in A1 is “(6),” and that A1[A4[3]−1]=6 is the trailing non-zero element of “(6).” Also, Eq. (6) shows that A4 has a length equal to the total number of rows of M1, which can be the length of A1 minus one.

Eq. (6) also shows that, rows of M1 represented in A1 can be decoded from A1 and A4. That is, A1[A3[i]] is the starting non-zero element in row i of M1 represented in A1, and A1[A4[i]−1] is the trailing non-zero element in row i of M1 represented in A1. Similarly, column indices of elements of the rows of M1 can be decoded from A2, A3, and A4, by which M1 can be fully reconstructed. That is, A2[A3[i]] is the column index of the starting non-zero element in row i of M1 represented in A1, and A2[A4[i]−1] is the column index of the trailing non-zero element in row i of M1 represented in A1. For example, rewriting A1 as [(1) (8 7 2) (3 5) (6 9 4)] and A2 as [(1) (3 6 0) (2 5) (6 4 7)] where numbers in each parenthesis pair corresponds to a row in M2, A3[1]=1, it can be seen that row 1 of M/represented in A1 is “(8 7),” that A1[A3[1]]=8 is the starting non-zero element of “(8 7),” that A2[A3[1]]=3 is the column index of the starting non-zero element of “(8 7),” that A4[1]=3, A1[A4[1]−1]=7 is the trailing non-zero element of “(8 7),” and that A2[A4[1]−1]=6 is the column index of the trailing non-zero element of “(8 7).”, M1 can be fully reconstructed after decoding the rows of M1 and each column index of the elements in the rows using A1, A2, A3, and A4.

As shown and described in association with Eqs. (1)-(6), although the first to fourth arrays (e.g., A1 to A4) are encoded only from the second sparse matrix (e.g., M2), they include full information to reconstruct both the first and second sparse matrices (e.g., M1 and M2) because they use a hierarchical structure to store the encoded information. Thus, in applications of the multi-level sparse neural network, there is no need to store the first and second sparse matrices separately. Because the storage cost of the third and fourth arrays (e.g., A3 and A4) is generally negligible compared with the storage cost of the first and second arrays (e.g., A1 and A2), the storage cost for the multi-level sparse neural network can be almost the same as the storage cost of the least sparse neural network sub-model (e.g., M2) because of the hierarchical structure. In two-sub-model scenarios, compared with a solution of storing two separate sparse neural network sub-models, the reduction of the storage cost brought by the proposed methods herein can be above 20% to 30%. Further, the storage cost for a multi-level sparse neural network that encodes multiple sub-models can slightly increase due to more A3- or A4-type arrays. However, the increase of such storage cost is also generally negligible compared with the storage cost of the first and second arrays (e.g., A1 and A2). In the multi-sub-model scenarios, the storage cost for the multi-level sparse neural network can still be on par with the storage cost of the least sparse neural network sub-model due to the hierarchical structure. Such a feature can bring great extendibility of the proposed methods, apparatuses, and systems, in which almost an arbitrary number of sub-models can be encoded for applications at a pseudo-constant storage cost.

In some embodiments, rather than storing multiple arrays corresponding to different sub-models having different sparsity levels, the outputted sparse-matrix representation can store only the arrays corresponding to a single sub-model and use flag data to indicate the corresponding sparsity level of the sparse-matrix representation. For example, the outputted sparse-matrix representation can include the first array (e.g., A1 in Eq. (3)), the second array (e.g., A2 in Eq. (4)), the third array (e.g., A3 in Eq. (5)), and flag data (e.g., a bit) for indicating a sparsity level. In such as case, the flag data can be used to indicate that the outputted sparse-matrix representation has a sparsity level corresponding to M2 in Eq. (2). As another example, the outputted sparse-matrix representation can include the first array (e.g., A1 in Eq. (3)), the second array (e.g., A2 in Eq. (4)), the fourth array (e.g., A4 in Eq. (6)), and flag data (e.g., a bit) for indicating a sparsity level. In such as case, the flag data can be used to indicate that the outputted sparse-matrix representation has a sparsity level corresponding to M1 in Eq. (1).

Consistent with some embodiments of this disclosure, the method for providing a neural network with multiple sparsity levels can be performed for each layer of the neural network to obtain a multi-level sparse neural network. The multi-level sparse neural network can include a first sub-model (e.g., M1 as described associated with Eqs. (1)-(6)) and a second sub-model (e.g., M2 as described associated with Eqs. (1)-(6)). The first sub-model can include the first sparse matrix, and the second sub-model can include the second sparse matrix, where the first sub-model has a higher sparsity level than the second sub-model.

Aspects of this disclosure can relate to executing a neural network with multiple sparsity levels, including systems, apparatuses, methods, and non-transitory computer-readable media. For ease of description, a method is described below, with the understanding that aspects to the method apply equally to systems, apparatuses, and non-transitory computer-readable media. For example, some aspects of such a method can be implemented by a system, an apparatus, or as program codes or computer instructions stored in a non-transitory computer-readable medium. In a broadest sense, the method is not limited to any particular physical or electronic instrumentalities, but rather can be accomplished using many different instrumentalities.

The neural network with multiple sparsity levels can be executed by applying dynamic rerouting at any layer of the neural network. The “dynamic routing,” as used herein, can refer to an operation of switching using sub-models of the multi-level sparse neural network at a layer of the neural network during execution. For example, the neural network can switch from using a lower-sparsity level sub-model to using a high-sparsity level sub-model at a layer during the execution. In some embodiments, the dynamic routing can be performed in accordance with one or more criteria.

Consistent with some embodiments of this disclosure, the method for executing a neural network with multiple sparsity levels can include receiving a first sparse matrix associated with a layer of the neural network. The “receiving,” as used herein, can refers to accepting, taking in, admitting, gaining, acquiring, retrieving, obtaining, reading, accessing, collecting, or any operation for inputting. By way of example, the first sparse matrix can have a relatively lower sparsity level (e.g., similar to second sparse matrix 308 in FIG. 3).

In some embodiments, receiving the first sparse matrix can include receiving a sparse-matrix representation encoded based on a compressed sparse row (CSR), a compressed sparse column (CSC), a dictionary of keys (DOK), a list of list (LIL), or a coordinate list (COO), and decoding the first sparse matrix from the sparse-matrix representation.

In some embodiments, the sparse-matrix representation can be encoded based on the CSR and include a first array, a second array, a third array, and a fourth array. The first array can include the non-zero elements of the second sparse matrix in a row-by-row order (e.g., from top to bottom) of the second sparse matrix. Any element in a row of the second sparse matrix and belonging to the non-zero elements of the first sparse matrix can lead, in the first array, all elements in the row and not belonging to the non-zero elements of the first sparse matrix. The second array can include column indices in the second sparse matrix corresponding to respective array elements of the first array. The third array can include a first set of array indices in the first array, and array elements of the first array corresponding to the first set of array indices can include starting non-zero elements of each row of the second sparse matrix represented in the first array. The fourth array can include a second set of array indices in the first array, and array elements of the first array corresponding to the second set of array indices can include trailing non-zero elements in each row of the first sparse matrix. For example, the first array, second array, third array, and fourth array can be arrays A1, A2, A3, and A4, respectively, as described in association with Eqs. (1) to (6). In some embodiments, decoding the first sparse matrix from the sparse-matrix representation can include decoding the first sparse matrix using the first array, the second array, and the third array. In some embodiments, the sparse-matrix representation can include the first array, the second array, the third array, and flag data for indicating a sparsity level.

Consistent with some embodiments of this disclosure, the method for executing a neural network with multiple sparsity levels can also include determining whether an inference status meets a predetermined condition. The method can further include executing the layer using the first sparse matrix if the inference status does not meet the predetermined condition. The “inference status,” as used herein, can include any combination of any performance indicator or state associated with an apparatus or system that executes the neural network. For example, the inference status can include at least one of a predicted inference latency or a predicted processor utilization rate.

The predetermined condition can include any condition that can significantly frustrate user experience or QoS. In some embodiments, the predetermined condition can include at least one of a condition that the predicted inference latency exceeds a threshold latency or a condition that the predicted processor utilization rate exceeds a threshold rate. For example, if the inference of the neural network is an application of AI-based image enhancement, the predetermined condition can be set as that the predicted inference latency exceeds 200 milliseconds because a user can perceive the delay of task completion.

In some embodiments, the method for executing a neural network with multiple sparsity levels can further include determining the inference status based on at least one of a runtime condition associated with the system or a preset triggering condition. The “runtime condition” associated with a system, as used herein, can include a real-time status or state of the system that is performing a computer-implemented method (e.g., as program codes or computer instructions). For example, the runtime condition associated with the system can include at least one of a power consumption rate, a processing throughput, a processor utilization rate, a processor frequency, a temperature, or a battery power level. The “triggering condition,” as used herein, can include a status or state not associated with any apparatus or system that is performing the computer-implemented method. In some embodiments, the triggering condition can be predefined by an external input (e.g., a user input).

Consistent with some embodiments of this disclosure, the method can further include executing the layer using a second sparse matrix determined based on the first sparse matrix if the inference status meets the predetermined condition. The second matrix and the first matrix can have different sparsity levels. Non-zero elements of the first sparse matrix can include non-zero elements of the second sparse matrix. The non-zero elements of the second sparse matrix can have the same locations in the first sparse matrix and in the second sparse matrix. For example, the second sparse matrix (e.g., similar to first sparse matrix 304 in FIG. 3) can have a higher sparsity level than the first sparse matrix (e.g., similar to second sparse matrix 308 in FIG. 3), which can consume less computational resources and can reduce inference latency.

Consistent with some embodiments of this disclosure, the method for executing a neural network with multiple sparsity levels can further include decoding the second sparse matrix using the first array, the second array, the third array, and the fourth array if the inference status meets the predetermined condition.

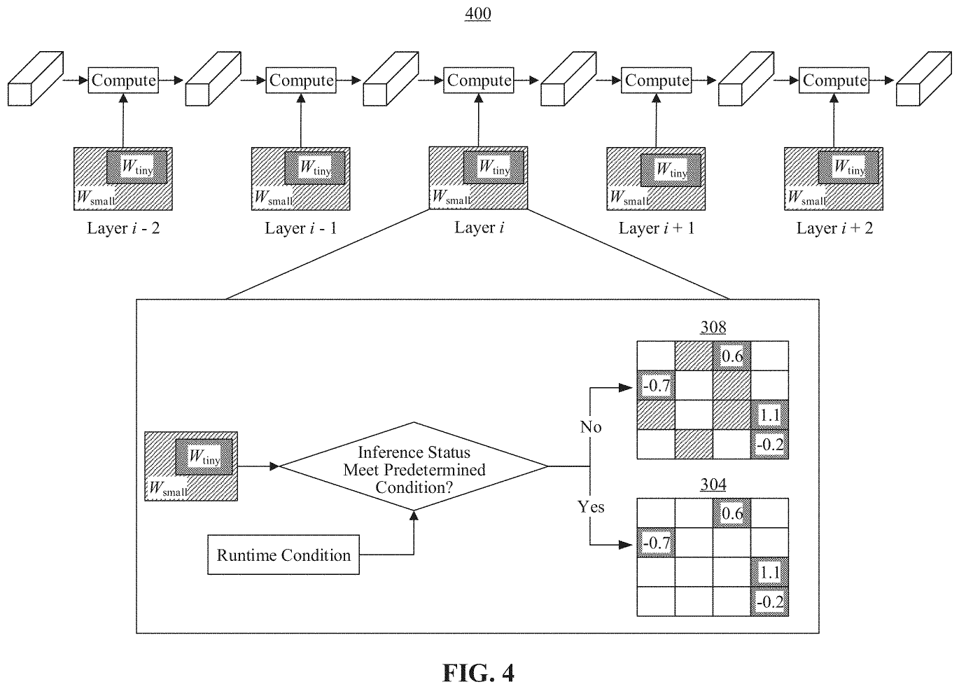

By way of example, FIG. 4 is a schematic representation of an example process 400 of executing a neural network with multiple sparsity levels, consistent with some embodiments of this disclosure. FIG. 4 depicts a neural network with multiple sparsity levels (e.g., the multi-level sparse neural network trained by process 300 in FIG. 3) that includes multiple layers (including layers i−2, i−1, i, i+1, and i+2). For ease of explanation without causing ambiguity, the “neural network with multiple sparsity levels” and the “multi-level sparse neural network” are used interchangeably hereinafter. As an example, the multi-level sparse neural network in FIG. 4 can include a first sub-model (e.g., the “small” model described as follows) and a second sub-model (e.g., the “tiny” model described as follows).

In FIG. 4, each layer can be executed to perform a computation (represented by boxes labeled as “Compute”) based on inputs or “activations” (represented by cuboids) and weights (represented by dotted boxes connecting to the “Compute” boxes by arrows). For example, the computation can include convolution, matrix-vector multiplication, or matrix-matrix multiplication. The direction of the inference is represented by the horizontal arrows connecting between the cuboids and the “Compute” boxes in FIG. 4.

The multi-level sparse neural network in FIG. 4 includes two sub-models with two different sparsity levels, a first sub-model having a higher sparsity level (referred to as a “small” sub-model) and a second sub-model having a lower sparsity level (referred to as a “tiny” sub-model). The small and tiny sub-models are sparsified neural networks, and the tiny sub-model can be a subset of the small sub-model. For example, at each layer, the multi-level sparse neural network in FIG. 4 can provide a first matrix having a higher sparsity level (e.g., similar to first sparse matrix 304 in FIG. 3, represented as “W_{tiny}” in FIG. 4) and a second matrix having a lower sparsity level (e.g., similar to second sparse matrix 308 in FIG. 3, represented as “Wₛₘₐₗₗ” in FIG. 4). W_{tiny} can be a subset of Wₛₘₐₗₗ (e.g., the values and locations of the non-zero elements of W_{tiny} being the same in Wₛₘₐₗₗ), which is represented by that the boxes of Wₛₘₐₗₗ encloses the boxes of W_{tiny} in FIG. 4. W_{tiny} can be different (e.g., having different dimensions, values, or sparsity levels) at each layer, and Wₛₘₐₗₗ can also be different (e.g., having different dimensions, values, or sparsity levels) at each layer. The tiny sub-model includes all W_{tiny} of all layers, and the small sub-model includes all Wₛₘₐₗₗ of all layers. When W_{tiny} is used at a layer, it can be referred to as that the tiny sub-model is being used for that layer. Similarly, when Wₛₘₐₗₗ is used at a layer, it can be referred to as that the small sub-model is being used for that layer.

Process 400 can perform the dynamic routing by dynamically selecting sub-models from the multi-level sparse neural network during the inference. For example, in FIG. 4, process 400 can use the small sub-model (e.g., using Wₛₘₐₗₗ for computation) at layers i−2 and i−1, and switch to use the tiny sub-model (e.g., using W_{tiny} for computation) from layer i, and keep using the tiny sub-model (e.g., using W_{tiny} for computation) for layers i+1 and i+2. By doing so, activations computed before layer i can be kept for avoiding wasting computational resources.

Process 400 can determine which sub-model to be used at each layer (e.g., at layer i). As depicted in FIG. 4, when the inference proceeds to layer i, process 400 can determine whether an inference status (e.g., a predicted inference latency or a predicted processor utilization rate) meets a predetermined condition. For example, the predetermined condition can be a condition that the predicted inference latency exceeds a threshold latency or a condition that the predicted processor utilization rate exceeds a threshold rate. If the inference status does not meet the predetermined condition, process 400 can select to use the small sub-model (e.g., second sparse matrix 308) at layer i for computation. Otherwise, process 400 can select to use the tiny sub-model (e.g., first sparse matrix 304) at layer i for computation, which can consume less computational resources and can reduce inference latency.

As an example of utilizing process 400, a device (e.g., a smartphone) executing a multi-level sparse neural network for AI-based image enhancement can estimate the inference latency to be 200 milliseconds before executing the multi-level sparse neural network. During the inference, when executing layer i (as illustrated in FIG. 4), the device can detect that the battery power level drops to a critical level and the predicted inference latency increases to 3 seconds due to reduced power of the processor. In this case, the device can select to use the tiny sub-model for layer i and all subsequent layers to complete the inference.

In some embodiments, as depicted in FIG. 4, process 400 can determine the inference status (e.g., using rerouting estimator 216 in FIG. 2A) based on a runtime condition associated with an apparatus or system that execute the inference. For example, the runtime condition can include at least one of a power consumption rate, a processing throughput, a processor utilization rate, a processor frequency, a temperature, or a battery power level.

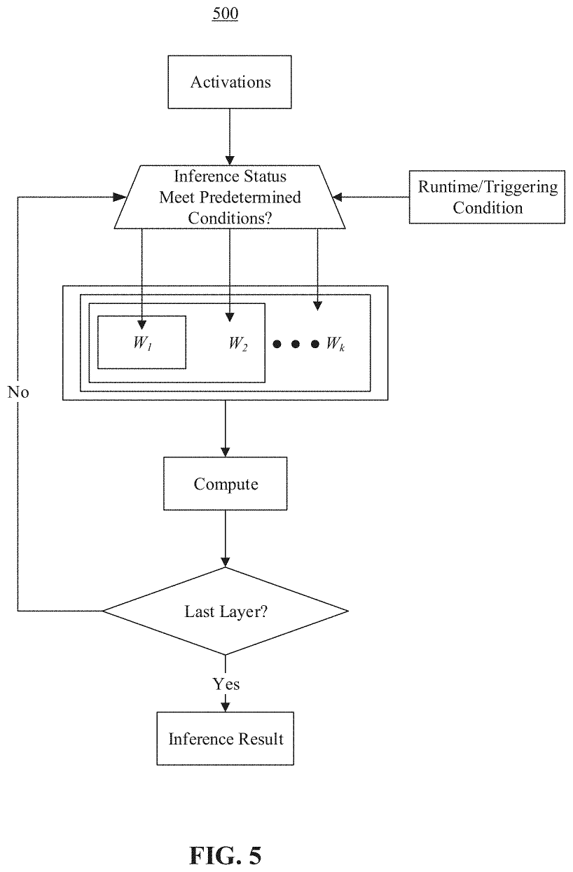

In some embodiments, the multi-level sparse neural network in FIG. 4 can include more than two sub-models. By way of example, FIG. 5 is a schematic representation of an example process 500 of executing a neural network with multiple sparsity levels, consistent with some embodiments of this disclosure. Process 500 can be performed at each layer (e.g., layer i in FIG. 4) of the multi-level sparse neural network.

In FIG. 5, the multi-level sparse neural network can include k sub-models (k being an integer) that can be referred to as sub-model 1, sub-model 2, . . . , sub-model k. The k sub-models are sparsified neural networks. Sub-model 1 can be a subset of sub-model 2, sub-model 2 can be a subset of sub-model 3, and so on. For example, at each layer, the multi-level sparse neural network in FIG. 5 can provide a first matrix (represented by W₁ in FIG. 5) having a first sparsity level, a second matrix (represented by W₂ in FIG. 5) having a second sparsity level lower than the first sparsity level, a third matrix having a third sparsity level lower than the second sparsity level, and so on. W₁ can be a subset of W₂ (e.g., the values and locations of the non-zero elements of W₁ being the same in W₂), which is represented by that the box of W₂ encloses the box of W₁ in FIG. 5. Wₖ can be the largest superset of all matrices (including W₁ and W₂), which is represented by that the box of Wₖ encloses all the boxes (including the boxes of W₁ and W₂) in FIG. 5. In some embodiments, the k sub-models can be generated by repeating process 300 in FIG. 3 for multiple iterations. In each iteration, the sparse matrix outputted from a previous iteration can be used as an input to generate a less sparse matrix (e.g., through direct re-densing or a DSD method).

In FIG. 5, at the beginning, activations can be inputted to a conditional multiplexer (represented by the trapezoid block) at which process 500 can determine whether an inference status meets one of a set of predetermined conditions. For example, the conditional multiplexer can be implemented as a software or hardware module (e.g., rerouting estimator 216 in FIG. 2A). Based on what predetermined condition the inference status meets, process 500 can dynamically select a corresponding sub-model (e.g., sub-model 1, sub-model 2, or sub-model k) for computation (represented by the “Compute” block in FIG. 5). In some embodiments, process 500 can determine the inference status (e.g., using rerouting estimator 216 in FIG. 2A) based on a runtime condition associated with an apparatus or system that execute the inference or a predefined triggering condition (e.g., a condition not associated with a status of the apparatus or system). After the computation, process 500 can determine whether the current layer is the last layer of the multi-level sparse neural network. If the current layer is the last layer, process 500 can output an inference result. Otherwise, process 500 can proceed to the next layer of the multi-level sparse neural network.

Because the dynamic routing can be performed at any layer of the neural network, the performance (e.g., prediction accuracy) of the dynamic routing can depend on at which layer the dynamic routing is performed. Using FIG. 4 as an example, if Wₛₘₐₗₗ and W_{tiny} are the same (e.g., having the same parameters, such as matrix weights) for each layer, switching from Wₛₘₐₗₗ to W_{tiny} at layer layer i (if the predetermined condition is met) can have a different performance from switching from Wₛₘₐₗₗ to W_{tiny} at layer layer i+1 (if the predetermined condition is met).

In some embodiments, to minimize the dependence between the performance of the multi-level sparse neural network and layers where the dynamic routing is performed, the multi-level sparse neural network can be optimized by training multiple, different sub-models for the neural network. For example, a first pair of Wₛₘₐₗₗ and W_{tiny} can be optimized for performing the dynamic routing at layer i−2, a second pair of Wₛₘₐₗₗ and W_{tiny} can be optimized for performing the dynamic routing at layer i−1, a third pair of Wₛₘₐₗₗ and W_{tiny} can be optimized for performing the dynamic routing at layer i, and so on.

Consistent with some embodiments of this disclosure, the method for providing a neural network with multiple sparsity levels can include re-training the neural network to update a parameter associated with the first sparse matrix by using a matrix at a first sparsity level and being associated with a first layer of the neural network after the layer and using a matrix at a second sparsity level and being associated with a second layer of the neural network before the layer. The first sparse matrix can have the first sparsity level, and the second sparse matrix can have the second sparsity level. The method can further include outputting the parameter for executing the neural network. In some embodiments, the parameter associated with the first sparse matrix can include at least one of a bias or a weight related to batch normalization.

By way of example using FIG. 4, the layer for which the neural network is re-trained for can be layer i. The first sparse matrix can be a sparse matrix (e.g., similar to second sparse matrix 308 in FIG. 3) in Wₛₘₐₗₗ that has the first sparsity level, and the second sparse matrix can be a sparse matrix (e.g., similar to first sparse matrix 304 in FIG. 3) in W_{tiny} that has the second sparsity level. The first layer can be layer i+1 in FIG. 4. The second layer can be layer i−1 in FIG. 4. The matrix at the first sparsity level can be associated with layer i+1. The matrix at the second sparsity level can be associated with layer i−1. During the re-training, a parameter (e.g., a bias or a weight related to batch normalization) associated with the first sparse matrix can be updated for optimizing the neural network. By repeating the re-training process for each layer of the neural network, multiple, optimized sub-models of the neural network can be obtained for performing the dynamic routing.

By way of example using FIG. 4, for optimization regarding layer i, all parameters (e.g., weights and hyper parameters) of all layers in Wₛₘₐₗₗ before layer i can be fixed before re-training the neural network. The weights can be any weight values to be used in convolution, matrix-vector multiplication, matrix-matrix multiplication, or any other weight values for operations or calculations in the neural network. The hyper parameters can include biases, weights related to batch normalization, running means, running variances, or any other hyper parameter related to executing Wₛₘₐₗₗ. During the re-training, for all layers in W_{tiny} after layer i (including layer i), all the weights of W_{tiny} can be fixed, in which only parameters of W_{tiny} (e.g., the parameter associated with the first sparse matrix) are allowed to be changed.

Consistent with some embodiments of this disclosure, the dynamic routing can be performed before the inference of the neural network. For example, before the inference, based on a determination that whether the inference status meets the predetermined condition, the first sparse matrix or the second sparse matrix can be selected to execute the first layer of the neural network.

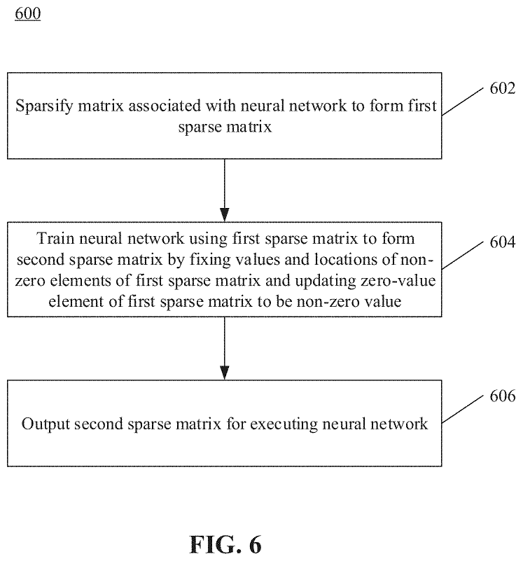

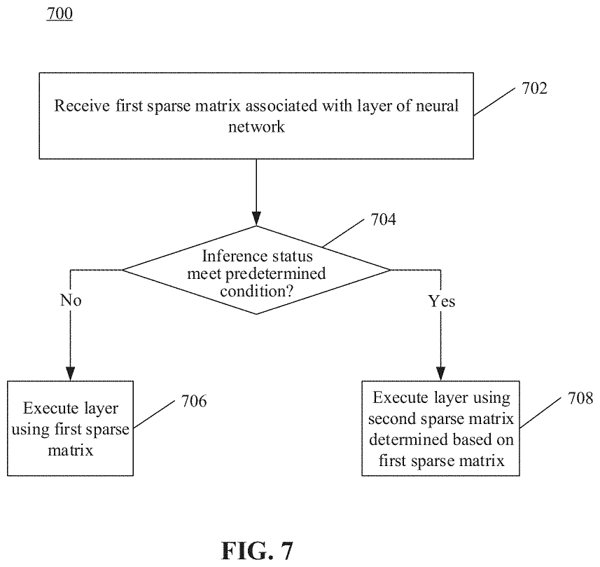

Consistent with some embodiments of this disclosure, FIGS. 6-7 illustrate flowcharts of example methods 600 and 700. Methods 600 and 700 can be performed by at least one processor (e.g., neural network accelerator 200, host unit 220, or command processor 204 in FIG. 2A). In some embodiments, methods 600 and 700 can be implemented as a computer program product (e.g., embodied in a computer-readable medium) that includes computer-executable instructions (e.g., program codes) to be executed by a computer (e.g., the configurations or architectures as shown in FIGS. 2A-2D). In some embodiments, methods 600 and 700 can be implemented as a hardware product (e.g., host memory 221 in FIG. 2A or local memory 2032 in FIGS. 2B-2C) that stores computer-executable instructions (e.g., program codes), and the hardware product can be a standalone or integrated part of any of the configurations or architectures as shown in FIGS. 2A-2D.

By way of example, FIG. 6 illustrates a flowchart of method 600 for providing a neural network with multiple sparsity levels, consistent with some embodiments of this disclosure. The neural network can be neural network 100A in FIG. 1A, for example.

At step 602, the processor sparsifies a matrix associated with the neural network to form a first sparse matrix. In some embodiments, the processor can sparsify the matrix by applying an alternating direction method of multipliers (ADMM) to the matrix.

At step 604, the processor trains the neural network using the first sparse matrix to form a second sparse matrix by fixing values and locations of non-zero elements of the first sparse matrix and updating a zero-value element of the first sparse matrix to be a non-zero value.

In some embodiments, the processor can train the neural network using the first sparse matrix to form a third matrix (e.g., dense matrix 306 in FIG. 3) by fixing the values and the locations of the non-zero elements of the first sparse matrix and updating a zero-value element of the first sparse matrix to be a non-zero value. The processor can then sparsify the third matrix to form the second sparse matrix. The non-zero elements of the first sparse matrix can have the same locations in the first sparse matrix, in the third matrix, and in the second sparse matrix. In some embodiments, the processor can sparsify the third matrix by applying an ADMM to the third matrix. In some embodiments, for forming the second sparse matrix, the processor can set the zero-value element of the first sparse matrix to be a random number and train the neural network using the first sparse matrix including the random number.

Still referring to FIG. 6, at step 606, the processor outputs the second sparse matrix for executing the neural network. In some embodiments, the processor can encode the second sparse matrix to be a sparse-matrix representation based on a compressed sparse row (CSR), a compressed sparse column (CSC), a dictionary of keys (DOK), a list of list (LIL), or a coordinate list (COO). The processor can then output the sparse-matrix representation for executing the neural network.

In some embodiments, the sparse-matrix representation can be based on the CSR and include a first array, a second array, a third array, and a fourth array. The first array can include the non-zero elements of the second sparse matrix in a row-by-row order (e.g., from top to bottom) of the second sparse matrix. Any element in a row of the second sparse matrix and belonging to the non-zero elements of the first sparse matrix can lead, in the first array, all elements in the row and not belonging to the non-zero elements of the first sparse matrix. The second array can include column indices in the second sparse matrix corresponding to respective array elements of the first array. The third array can include a first set of array indices in the first array, and array elements of the first array corresponding to the first set of array indices can include starting non-zero elements of each row of the second sparse matrix represented in the first array. The fourth array can include a second set of array indices in the first array, and array elements of the first array corresponding to the second set of array indices can include trailing non-zero elements in each row of the first sparse matrix.

Consistent with some embodiments of this disclosure, the matrix at step 602 can be associated with a layer (e.g., layer i in FIG. 4) of the neural network. The processor can re-train the neural network to update a parameter associated with the first sparse matrix by using a matrix at a first sparsity level (e.g., the sparsity level of the first sparse matrix) and being associated with a first layer of the neural network after the layer and using a matrix at a second sparsity level (e.g., the sparsity level of the second sparse matrix) and being associated with a second layer of the neural network before the layer. The processor can then output the parameter for executing the neural network. In some embodiments, the parameter associated with the first sparse matrix can include at least one of a bias or a weight related to batch normalization.

By way of example, FIG. 7 illustrates a flowchart of method 700 for executing a neural network with multiple sparsity levels, consistent with some embodiments of this disclosure. The neural network can be neural network 100A in FIG. 1A, for example. In some embodiments, method 700 can be implemented as a computer program product (e.g., embodied in a computer-readable medium) that includes computer-executable instructions (e.g., program codes) to be executed by a computer processor (e.g., command processor 204 in FIG. 2A or core 202 in FIGS. 2A-2C). In some embodiments, method 700 can be implemented as a hardware product (e.g., host memory 221 in FIG. 2A or local memory 2032 in FIGS. 2B-2C) that stores computer-executable instructions (e.g., program codes).

At step 702, the processor receives a first sparse matrix (e.g., a matrix similar to second sparse matrix 308 in FIG. 3) associated with a layer of the neural network. In some embodiments, the processor can receive a sparse-matrix representation encoded based on a compressed sparse row (CSR), a compressed sparse column (CSC), a dictionary of keys (DOK), a list of list (LIL), or a coordinate list (COO), and decoding the first sparse matrix from the sparse-matrix representation.

In some embodiments, the sparse-matrix representation can be encoded based on the CSR and include a first array, a second array, a third array, and a fourth array. For example, the first array, second array, third array, and fourth array can be arrays A1, A2, A3, and A4, respectively, as described in association with Eqs. (1) to (6). The first array can include the non-zero elements of the second sparse matrix in a row-by-row order (e.g., from top to bottom) of the second sparse matrix. Any element in a row of the second sparse matrix and belonging to the non-zero elements of the first sparse matrix can lead, in the first array, all elements in the row and not belonging to the non-zero elements of the first sparse matrix. The second array can include column indices in the second sparse matrix corresponding to respective array elements of the first array. The third array can include a first set of array indices in the first array, and array elements of the first array corresponding to the first set of array indices can include starting non-zero elements of each row of the second sparse matrix represented in the first array. The fourth array can include a second set of array indices in the first array, and array elements of the first array corresponding to the second set of array indices can include trailing non-zero elements in each row of the first sparse matrix.

In some embodiments, the processor can decode the first sparse matrix from the sparse-matrix representation by decoding the first sparse matrix using the first array, the second array, and the third array. In some embodiments, the sparse-matrix representation can include the first array, the second array, the third array, and flag data for indicating a sparsity level.

Still referring to FIG. 7, at step 704, the processor determines whether an inference status meets a predetermined condition. If the inference status does not meet the predetermined condition, process 700 proceeds to step 706. Otherwise, process 700 proceeds to step 708. In some embodiments, the processor can implement step 704 as instructions or program codes associated with rerouting estimator 216 in FIG. 2. For example, the inference status can include at least one of a predicted inference latency or a predicted processor utilization rate. In some embodiments, the processor can determine the inference status based on at least one of a runtime condition associated with the system or a preset triggering condition. For example, the runtime condition associated with the system can include at least one of a power consumption rate, a processing throughput, a processor utilization rate, a processor frequency, a temperature, or a battery power level. In some embodiments, the triggering condition can be predefined by an external input (e.g., a user input).

In some embodiments, the predetermined condition can include at least one of a condition that the predicted inference latency exceeds a threshold latency or a condition that the predicted processor utilization rate exceeds a threshold rate.

Still referring to FIG. 7, at step 706, the processor executes the layer using the first sparse matrix (e.g., Wₛₘₐₗₗ in FIG. 4). At step 708, the processor executes the layer using a second sparse matrix (e.g., W_{tiny} in FIG. 4) determined based on the first sparse matrix. The second matrix and the first matrix can have different sparsity levels. Non-zero elements of the first sparse matrix can include non-zero elements of the second sparse matrix. The non-zero elements of the second sparse matrix can have the same locations in the first sparse matrix and in the second sparse matrix. For example, the second sparse matrix can have a higher sparsity level than the first sparse matrix, which can consume less computational resources and can reduce inference latency.

Consistent with some embodiments of this disclosure, the processor can decode the second sparse matrix using the first array, the second array, the third array, and the fourth array if the inference status meets the predetermined condition.

By applying the disclosed methods, systems, and apparatuses for providing a neural network with multiple sparsity levels, sub-models at desired sparsity levels can be selected before and during the inference. Doing so can reduce the storage cost for storing multiple sub-models separately. For example, compared with storing two separate sub-models, the storage cost of the disclosed methods and systems can be averagely reduced by 20% to 30%. If more sub-models are used for a single application, the percentage of the reduced storage cost can be even higher. The overall storage savings can be larger if the sparse-matrix representation (e.g., modified from the CSR format) can be further compressed (e.g., by combining one or more arrays into one).

By applying the disclosed methods, systems, and apparatuses for executing a neural network with multiple sparsity levels (e.g., by applying the dynamic routing), QoS and user experience can be greatly improved by maintaining or reducing the inference latency of the neural network without compromising the quality of the inference results. For example, a best sub-model allowable by a runtime condition can be selected before the inference, and if the runtime condition is changed during the inference, the next best sub-model allowable by the changed runtime condition can be selected to ensure the inference latency is not significantly increased.

In some embodiments, a non-transitory computer-readable storage medium including instructions is also provided, and the instructions can be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device can include one or more processors (CPUs), an input/output interface, a network interface, and/or a memory.

The embodiments can further be described using the following clauses:
1. A system for providing a neural network with multiple sparsity levels, comprising:
at least one memory for storing instructions; and
at least one processor configured to execute the instructions to cause the system to perform:
sparsifying a matrix associated with the neural network to form a first sparse matrix;
training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix comprises the non-zero elements of the first sparse matrix; and
outputting the second sparse matrix for executing the neural network.
2. The system of clause 1, wherein sparsifying the matrix associated with the neural network to form the first sparse matrix comprises:
sparsifying the matrix by applying an alternating direction method of multipliers (ADMM) to the matrix.
3. The system of any of clauses 1-2, wherein training the neural network using the first sparse matrix to form the second sparse matrix comprises:
training the neural network using the first sparse matrix to form a third matrix by fixing the values and the locations of the non-zero elements of the first sparse matrix and updating a zero-value element of the first sparse matrix to be a non-zero value; and
sparsifying the third matrix to form the second sparse matrix, wherein the non-zero elements of the first sparse matrix have the same locations in the first sparse matrix, in the third matrix, and in the second sparse matrix.
4. The system of clause 3, wherein sparsifying the third matrix to form the second sparse matrix comprises:
sparsifying the third matrix by applying an ADMM to the third matrix.
5. The system of any of clauses 1-4, wherein training the neural network using the first sparse matrix to form the second sparse matrix comprises:
setting the zero-value element of the first sparse matrix to be a random number; and
training the neural network using the first sparse matrix comprising the random number.
6. The system of any of clauses 1-5, wherein outputting the second sparse matrix comprises:
encoding the second sparse matrix to be a sparse-matrix representation based on a compressed sparse row (CSR), a compressed sparse column (CSC), a dictionary of keys (DOK), a list of list (LIL), or a coordinate list (COO); and outputting the sparse-matrix representation for executing the neural network.
7. The system of clause 6, wherein the sparse-matrix representation is based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements of each row of the second sparse matrix represented in the first array; and
a fourth array comprising a second set of array indices in the first array, wherein array elements of the first array corresponding to the second set of array indices are trailing non-zero elements in each row of the first sparse matrix.
8. The system of clause 7, wherein the sparse-matrix representation comprises the first array, the second array, the third array, and flag data for indicating a sparsity level.
9. The system of any of clauses 1-8, wherein the matrix is associated with a layer of the neural network, and the at least one processor is further configured to execute the instructions to cause the system to perform:
re-training the neural network to update a parameter associated with the first sparse matrix by using a matrix at a first sparsity level and being associated with a first layer of the neural network after the layer and using a matrix at a second sparsity level and being associated with a second layer of the neural network before the layer, wherein the first sparse matrix has the first sparsity level and the second sparse matrix has the second sparsity level; and
outputting the parameter for executing the neural network.
10. The system of clause 9, wherein the parameter comprises at least one of a bias or a weight related to batch normalization.
11. A non-transitory computer-readable storage medium storing a set of instructions that is executable by at least one processor of a computer to cause the computer to perform a method for providing a neural network with multiple sparsity levels, the method comprising:
sparsifying a matrix associated with the neural network to form a first sparse matrix;
training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix comprises the non-zero elements of the first sparse matrix; and
outputting the second sparse matrix for executing the neural network.
12. The non-transitory computer-readable storage medium of clause 11, wherein sparsifying the matrix associated with the neural network to form the first sparse matrix comprises:
sparsifying the matrix by applying an alternating direction method of multipliers (ADMM) to the matrix.
13. The non-transitory computer-readable storage medium of any of clauses 11-12, wherein training the neural network using the first sparse matrix to form the second sparse matrix comprises:
training the neural network using the first sparse matrix to form a third matrix by fixing the values and the locations of the non-zero elements of the first sparse matrix and updating a zero-value element of the first sparse matrix to be a non-zero value; and
sparsifying the third matrix to form the second sparse matrix, wherein the non-zero elements of the first sparse matrix have the same locations in the first sparse matrix, in the third matrix, and in the second sparse matrix.
14. The non-transitory computer-readable storage medium of clause 13, wherein sparsifying the third matrix to form the second sparse matrix comprises:
sparsifying the third matrix by applying an ADMM to the third matrix.
15. The non-transitory computer-readable storage medium of any of clauses 11-14, wherein training the neural network using the first sparse matrix to form the second sparse matrix comprises:
setting the zero-value element of the first sparse matrix to be a random number; and
training the neural network using the first sparse matrix comprising the random number.
16. The non-transitory computer-readable storage medium of any of clauses 11-15, wherein outputting the second sparse matrix comprises:
encoding the second sparse matrix to be a sparse-matrix representation based on a compressed sparse row (CSR), a compressed sparse column (CSC), a dictionary of keys (DOK), a list of list (LIL), or a coordinate list (COO); and
outputting the sparse-matrix representation for executing the neural network.
17. The non-transitory computer-readable storage medium of clause 16, wherein the sparse-matrix representation is based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements of each row of the second sparse matrix represented in the first array; and
a fourth array comprising a second set of array indices in the first array, wherein array elements of the first array corresponding to the second set of array indices are trailing non-zero elements in each row of the first sparse matrix.
18. The non-transitory computer-readable storage medium of clause 17, wherein the sparse-matrix representation comprises the first array, the second array, the third array, and flag data for indicating a sparsity level.
19. The non-transitory computer-readable storage medium of any of clauses 11-18, wherein the matrix is associated with a layer of the neural network, and the set of instructions that is executable by the at least one processor of the computer causes the computer to further perform:
re-training the neural network to update a parameter associated with the first sparse matrix by using a matrix at a first sparsity level and being associated with a first layer of the neural network after the layer and using a matrix at a second sparsity level and being associated with a second layer of the neural network before the layer, wherein the first sparse matrix has the first sparsity level and the second sparse matrix has the second sparsity level; and
outputting the parameter for executing the neural network.
20. The non-transitory computer-readable storage medium of clause 19, wherein the parameter comprises at least one of a bias or a weight related to batch normalization.
21. A computer-implemented method for providing a neural network with multiple sparsity levels, comprising:
sparsifying a matrix associated with the neural network to form a first sparse matrix;
training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix comprises the non-zero elements of the first sparse matrix; and
outputting the second sparse matrix for executing the neural network.
22. The computer-implemented method of clause 21, wherein sparsifying the matrix associated with the neural network to form the first sparse matrix comprises:
sparsifying the matrix by applying an alternating direction computer-implemented method of multipliers (ADMM) to the matrix.
23. The computer-implemented method of any of clauses 21-22, wherein training the neural network using the first sparse matrix to form the second sparse matrix comprises:
training the neural network using the first sparse matrix to form a third matrix by fixing the values and the locations of the non-zero elements of the first sparse matrix and updating a zero-value element of the first sparse matrix to be a non-zero value; and
sparsifying the third matrix to form the second sparse matrix, wherein the non-zero elements of the first sparse matrix have the same locations in the first sparse matrix, in the third matrix, and in the second sparse matrix.
24. The computer-implemented method of clause 23, wherein sparsifying the third matrix to form the second sparse matrix comprises:
sparsifying the third matrix by applying an ADMM to the third matrix.
25. The computer-implemented method of any of clauses 21-24, wherein training the neural network using the first sparse matrix to form the second sparse matrix comprises:
setting the zero-value element of the first sparse matrix to be a random number; and
training the neural network using the first sparse matrix comprising the random number.
26. The computer-implemented method of any of clauses 21-24, wherein outputting the second sparse matrix comprises:
encoding the second sparse matrix to be a sparse-matrix representation based on a compressed sparse row (CSR), a compressed sparse column (CSC), a dictionary of keys (DOK), a list of list (LIL), or a coordinate list (COO); and
outputting the sparse-matrix representation for executing the neural network.
27. The computer-implemented method of clause 26, wherein the sparse-matrix representation is based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements in each row of the second sparse matrix represented in the first array; and
a fourth array comprising a second set of array indices in the first array, wherein array elements of the first array corresponding to the second set of array indices are trailing non-zero elements in each row of the first sparse matrix.
28. The computer-implemented method of clause 27, wherein the sparse-matrix representation comprises the first array, the second array, the third array, and flag data for indicating a sparsity level.
29. The computer-implemented method of any of clauses 21-28, wherein the matrix is associated with a layer of the neural network, and the computer-implemented method further comprises:
re-training the neural network to update a parameter associated with the first sparse matrix by using a matrix at a first sparsity level and being associated with a first layer of the neural network after the layer and using a matrix at a second sparsity level and being associated with a second layer of the neural network before the layer, wherein the first sparse matrix has the first sparsity level and the second sparse matrix has the second sparsity level; and
outputting the parameter for executing the neural network.
30. The computer-implemented method of clause 19, wherein the parameter comprises at least one of a bias or a weight related to batch normalization.
31. A system for executing a neural network with multiple sparsity levels, comprising:
at least one memory for storing instructions; and
at least one processor configured to execute the instructions to cause the system to perform:
receiving a first sparse matrix associated with a layer of the neural network;
determining whether an inference status meets a predetermined condition;
executing the layer using the first sparse matrix if the inference status does not meet the predetermined condition; and
executing the layer using a second sparse matrix determined based on the first sparse matrix if the inference status meets the predetermined condition, wherein
the second matrix and the first matrix have different sparsity levels, non-zero elements of the first sparse matrix comprise non-zero elements of the second sparse matrix, and
the non-zero elements of the second sparse matrix have the same locations in the first sparse matrix and in the second sparse matrix.
32. The system of clause 31, wherein receiving the first sparse matrix comprises:
receiving a sparse-matrix representation encoded based on a compressed sparse row (CSR), a compressed sparse column (CSC), a dictionary of keys (DOK), a list of list (LIL), or a coordinate list (COO); and
decoding the first sparse matrix from the sparse-matrix representation.
33. The system of clause 32, wherein the sparse-matrix representation is encoded based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements in each row of the second sparse matrix represented in the first array; and
a fourth array comprising a second set of array indices in the first array, wherein array elements of the first array corresponding to the second set of array indices are trailing non-zero elements in each row of the first sparse matrix.
34. The system of clause 33, wherein decoding the first sparse matrix from the sparse-matrix representation comprises:
decoding the first sparse matrix using the first array, the second array, and the third array.
35. The system of any of clauses 33-34, wherein the at least one processor is further configured to execute the instructions to cause the system to perform:
decoding the second sparse matrix using the first array, the second array, the third array, and the fourth array if the inference status meets the predetermined condition.
36. The system of any of clauses 33-35, wherein the sparse-matrix representation comprises the first array, the second array, the third array, and flag data for indicating a sparsity level.
37. The system of any of clauses 31-36, wherein the inference status comprises at least one of a predicted inference latency or a predicted processor utilization rate.
38. The system of clause 37, wherein the predetermined condition comprises at least one of a condition that the predicted inference latency exceeds a threshold latency or a condition that the predicted processor utilization rate exceeds a threshold rate.
39. The system of any of clauses 31-38, wherein the at least one processor is further configured to execute the instructions to cause the system to perform:
determining the inference status based on at least one of a runtime condition associated with the system or a preset triggering condition.
40. The system of clause 39, wherein the runtime condition associated with the system comprises at least one of a power consumption rate, a processing throughput, a processor utilization rate, a processor frequency, a temperature, or a battery power level.
41. A non-transitory computer-readable storage medium storing a set of instructions that is executable by at least one processor of a computer to cause the computer to perform a method for executing a neural network with multiple sparsity levels, the method comprising:
receiving a first sparse matrix associated with a layer of the neural network;
determining whether an inference status meets a predetermined condition;
executing the layer using the first sparse matrix if the inference status does not meet the predetermined condition; and
executing the layer using a second sparse matrix determined based on the first sparse matrix if the inference status meets the predetermined condition, wherein
the second matrix and the first matrix have different sparsity levels,
non-zero elements of the first sparse matrix comprise non-zero elements of the second sparse matrix, and
the non-zero elements of the second sparse matrix have the same locations in the first sparse matrix and in the second sparse matrix.
42. The non-transitory computer-readable storage medium of clause 41, wherein receiving the first sparse matrix comprises:
receiving a sparse-matrix representation encoded based on a compressed sparse row (CSR), a compressed sparse column (CSC), a dictionary of keys (DOK), a list of list (LIL), or a coordinate list (COO); and
decoding the first sparse matrix from the sparse-matrix representation.
43. The non-transitory computer-readable storage medium of clause 42, wherein the sparse-matrix representation is encoded based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements in each row of the second sparse matrix represented in the first array; and
a fourth array comprising a second set of array indices in the first array, wherein array elements of the first array corresponding to the second set of array indices are trailing non-zero elements in each row of the first sparse matrix.
44. The non-transitory computer-readable storage medium of clause 43, wherein decoding the first sparse matrix from the sparse-matrix representation comprises:
decoding the first sparse matrix using the first array, the second array, and the third array.
45. The non-transitory computer-readable storage medium of any of clauses 43-44, wherein the set of instructions that is executable by the at least one processor of the computer causes the computer to further perform:
decoding the second sparse matrix using the first array, the second array, the third array, and the fourth array if the inference status meets the predetermined condition.
46. The non-transitory computer-readable storage medium of any of clauses 43-45, wherein the sparse-matrix representation comprises the first array, the second array, the third array, and flag data for indicating a sparsity level.
47. The non-transitory computer-readable storage medium of any of clauses 41-46, wherein the inference status comprises at least one of a predicted inference latency or a predicted processor utilization rate.
48. The non-transitory computer-readable storage medium of clause 47, wherein the predetermined condition comprises at least one of a condition that the predicted inference latency exceeds a threshold latency or a condition that the predicted processor utilization rate exceeds a threshold rate.
49. The non-transitory computer-readable storage medium of any of clauses 41-48, wherein the set of instructions that is executable by the at least one processor of the computer causes the computer to further perform:
determining the inference status based on at least one of a runtime condition associated with the computer or a preset triggering condition.
50. The non-transitory computer-readable storage medium of clause 49, wherein the runtime condition associated with the computer comprises at least one of a power consumption rate, a processing throughput, a processor utilization rate, a processor frequency, a temperature, or a battery power level.
51. A computer-implemented method for executing a neural network with multiple sparsity levels, comprising:
receiving a first sparse matrix associated with a layer of the neural network;
determining whether an inference status meets a predetermined condition;
executing the layer based on the determination, wherein the layer is executed using the first sparse matrix in response to the inference status not meeting the predetermined condition and is executed using a second sparse matrix determined based on the first sparse matrix in response to the inference status meeting the predetermined condition, wherein
the second matrix and the first matrix have different sparsity levels,
non-zero elements of the first sparse matrix comprise non-zero elements of the second sparse matrix, and
the non-zero elements of the second sparse matrix have the same locations in the first sparse matrix and in the second sparse matrix.
52. The computer-implemented method of clause 51, wherein receiving the first sparse matrix comprises:
receiving a sparse-matrix representation encoded based on a compressed sparse row (CSR), a compressed sparse column (CSC), a dictionary of keys (DOK), a list of list (LIL), or a coordinate list (COO); and
decoding the first sparse matrix from the sparse-matrix representation.
53. The computer-implemented method of clause 52, wherein the sparse-matrix representation is encoded based on the CSR and comprises:
a first array comprising the non-zero elements of the second sparse matrix in a row-by-row order of the second sparse matrix, wherein any element in a row of the second sparse matrix and belonging to the non-zero elements of the first sparse matrix leads, in the first array, all elements in the row and not belonging to the non-zero elements of the first sparse matrix;
a second array comprising column indices in the second sparse matrix corresponding to respective array elements of the first array;
a third array comprising a first set of array indices in the first array, wherein array elements of the first array corresponding to the first set of array indices are starting non-zero elements in each row of the second sparse matrix represented in the first array; and
a fourth array comprising a second set of array indices in the first array, wherein array elements of the first array corresponding to the second set of array indices are trailing non-zero elements in each row of the first sparse matrix.
54. The computer-implemented method of clause 53, wherein decoding the first sparse matrix from the sparse-matrix representation comprises:
decoding the first sparse matrix using the first array, the second array, and the third array.
55. The computer-implemented method of any of clauses 53-54, further comprising:
decoding the second sparse matrix using the first array, the second array, the third array, and the fourth array if the inference status meets the predetermined condition.
56. The computer-implemented method of any of clauses 53-55, wherein the sparse-matrix representation comprises the first array, the second array, the third array, and flag data for indicating a sparsity level.
57. The computer-implemented method of any of clauses 51-56, wherein the inference status comprises at least one of a predicted inference latency or a predicted processor utilization rate.
58. The computer-implemented method of clause 57, wherein the predetermined condition comprises at least one of a condition that the predicted inference latency exceeds a threshold latency or a condition that the predicted processor utilization rate exceeds a threshold rate.
59. The computer-implemented method of any of clauses 51-58, further comprising:
determining the inference status based on at least one of a runtime condition associated with the computer or a preset triggering condition.
60. The computer-implemented method of clause 59, wherein the runtime condition associated with the computer comprises at least one of a power consumption rate, a processing throughput, a processor utilization rate, a processor frequency, a temperature, or a battery power level.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. As used herein, the indefinite articles “a” and “an” mean “one or more.” Similarly, the use of a plural term does not necessarily denote a plurality unless it is unambiguous in the given context.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units can be combined as one module/unit, and each of the above described modules/units can be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A non-transitory computer-readable storage medium storing a set of instructions that is executable by at least one processor of a computer to cause the computer to perform a method for providing a neural network with multiple sparsity levels, the method comprising:
sparsifying a matrix associated with the neural network to form a first sparse matrix;
training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix comprises the non-zero elements of the first sparse matrix; and
outputting the second sparse matrix for executing the neural network.

2. The non-transitory computer-readable storage medium of claim 1, wherein sparsifying the matrix associated with the neural network to form the first sparse matrix comprises:
sparsifying the matrix by applying an alternating direction method of multipliers (ADMM) to the matrix.

3. The non-transitory computer-readable storage medium of claim 1, wherein training the neural network using the first sparse matrix to form the second sparse matrix comprises:
training the neural network using the first sparse matrix to form a third matrix by fixing the values and the locations of the non-zero elements of the first sparse matrix and updating a zero-value element of the first sparse matrix to be a non-zero value; and
sparsifying the third matrix to form the second sparse matrix, wherein the non-zero elements of the first sparse matrix have the same locations in the first sparse matrix, in the third matrix, and in the second sparse matrix.

4. The non-transitory computer-readable storage medium of claim 1, wherein training the neural network using the first sparse matrix to form the second sparse matrix comprises:
setting the zero-value element of the first sparse matrix to be a random number; and
training the neural network using the first sparse matrix comprising the random number.

5. The non-transitory computer-readable storage medium of claim 1, wherein outputting the second sparse matrix comprises:
encoding the second sparse matrix to be a sparse-matrix representation based on a compressed sparse row (CSR), a compressed sparse column (CSC), a dictionary of keys (DOK), a list of list (LIL), or a coordinate list (COO); and
outputting the sparse-matrix representation for executing the neural network.

6. The non-transitory computer-readable storage medium of claim 5, wherein the sparse-matrix representation is based on the CSR and comprises at least one of a first array, a second array, a third array, or flag data for indicating a sparsity level.

7. The non-transitory computer-readable storage medium of claim 1, wherein the matrix is associated with a layer of the neural network, and the set of instructions that is executable by the at least one processor of the computer causes the computer to further perform:
re-training the neural network to update a parameter associated with the first sparse matrix by using a matrix at a first sparsity level and being associated with a first layer of the neural network after the layer and using a matrix at a second sparsity level and being associated with a second layer of the neural network before the layer, wherein the first sparse matrix has the first sparsity level and the second sparse matrix has the second sparsity level; and
outputting the parameter for executing the neural network.

8. The non-transitory computer-readable storage medium of claim 7, wherein the parameter comprises at least one of a bias or a weight related to batch normalization.

9. A system for providing a neural network with multiple sparsity levels, comprising:
at least one memory for storing instructions; and
at least one processor configured to execute the instructions to cause the system to perform:
sparsifying a matrix associated with the neural network to form a first sparse matrix;
training the neural network using the first sparse matrix to form a second sparse matrix by fixing values and locations of non-zero elements of the first sparse matrix and updating a zero-value element of the first sparse matrix to be a non-zero value, wherein non-zero elements of the second sparse matrix comprises the non-zero elements of the first sparse matrix; and
outputting the second sparse matrix for executing the neural network.

10. The system of claim 9, wherein training the neural network using the first sparse matrix to form the second sparse matrix comprises:
training the neural network using the first sparse matrix to form a third matrix by fixing the values and the locations of the non-zero elements of the first sparse matrix and updating a zero-value element of the first sparse matrix to be a non-zero value; and
sparsifying the third matrix to form the second sparse matrix, wherein the non-zero elements of the first sparse matrix have the same locations in the first sparse matrix, in the third matrix, and in the second sparse matrix.

11. The system of claim 9, wherein training the neural network using the first sparse matrix to form the second sparse matrix comprises:
setting the zero-value element of the first sparse matrix to be a random number; and
training the neural network using the first sparse matrix comprising the random number.

12. The system of claim 9, wherein outputting the second sparse matrix comprises:
encoding the second sparse matrix to be a sparse-matrix representation based on a compressed sparse row (CSR), a compressed sparse column (CSC), a dictionary of keys (DOK), a list of list (LIL), or a coordinate list (COO); and
outputting the sparse-matrix representation for executing the neural network.

13. The system of claim 12, wherein the sparse-matrix representation is based on the CSR and comprises at least one of a first array, a second array, a third array, or flag data for indicating a sparsity level.

14. The system of claim 9, wherein the matrix is associated with a layer of the neural network, and the at least one processor is further configured to execute the instructions to cause the system to perform:
re-training the neural network to update a parameter associated with the first sparse matrix by using a matrix at a first sparsity level and being associated with a first layer of the neural network after the layer and using a matrix at a second sparsity level and being associated with a second layer of the neural network before the layer, wherein the first sparse matrix has the first sparsity level and the second sparse matrix has the second sparsity level; and
outputting the parameter for executing the neural network, wherein the parameter comprises at least one of a bias or a weight related to batch normalization.

15. A non-transitory computer-readable storage medium storing a set of instructions that is executable by at least one processor of a computer to cause the computer to perform a method for executing a neural network with multiple sparsity levels, the method comprising:
receiving a first sparse matrix associated with a layer of the neural network;
determining whether an inference status meets a predetermined condition;
executing the layer using the first sparse matrix if the inference status does not meet the predetermined condition; and
executing the layer using a second sparse matrix determined based on the first sparse matrix if the inference status meets the predetermined condition, wherein
the second matrix and the first matrix have different sparsity levels,
non-zero elements of the first sparse matrix comprise non-zero elements of the second sparse matrix, and
the non-zero elements of the second sparse matrix have the same locations in the first sparse matrix and in the second sparse matrix.

16. The non-transitory computer-readable storage medium of claim 15, wherein receiving the first sparse matrix comprises:
receiving a sparse-matrix representation encoded based on a compressed sparse row (CSR), a compressed sparse column (CSC), a dictionary of keys (DOK), a list of list (LIL), or a coordinate list (COO); and
decoding the first sparse matrix from the sparse-matrix representation.

17. The non-transitory computer-readable storage medium of claim 16, wherein the sparse-matrix representation is encoded based on the CSR and comprises at least one of a first array, a second array, a third array, a fourth array, or flag data for indicating a sparsity level.

18. The non-transitory computer-readable storage medium of claim 17, wherein decoding the first sparse matrix from the sparse-matrix representation comprises:
decoding the first sparse matrix using the first array, the second array, and the third array.

19. The non-transitory computer-readable storage medium of claim 17, wherein the set of instructions that is executable by the at least one processor of the computer causes the computer to further perform:
decoding the second sparse matrix using the first array, the second array, the third array, and the fourth array if the inference status meets the predetermined condition.

20. The non-transitory computer-readable storage medium of claim 15, wherein the inference status comprises at least one of a predicted inference latency or a predicted processor utilization rate.

21. The non-transitory computer-readable storage medium of claim 20, wherein the predetermined condition comprises at least one of a condition that the predicted inference latency exceeds a threshold latency or a condition that the predicted processor utilization rate exceeds a threshold rate.

22. The non-transitory computer-readable storage medium of claim 15, wherein the set of instructions that is executable by the at least one processor of the computer causes the computer to further perform:
determining the inference status based on at least one of a runtime condition associated with the computer or a preset triggering condition.

23. The non-transitory computer-readable storage medium of claim 22, wherein the runtime condition associated with the computer comprises at least one of a power consumption rate, a processing throughput, a processor utilization rate, a processor frequency, a temperature, or a battery power level.

24. A system for executing a neural network with multiple sparsity levels, comprising:
at least one memory for storing instructions; and
at least one processor configured to execute the instructions to cause the system to perform:
receiving a first sparse matrix associated with a layer of the neural network;
determining whether an inference status meets a predetermined condition;
executing the layer using the first sparse matrix if the inference status does not meet the predetermined condition; and
executing the layer using a second sparse matrix determined based on the first sparse matrix if the inference status meets the predetermined condition, wherein the second matrix and the first matrix have different sparsity levels,
non-zero elements of the first sparse matrix comprise non-zero elements of the second sparse matrix, and
the non-zero elements of the second sparse matrix have the same locations in the first sparse matrix and in the second sparse matrix.

25. The system of claim 24, wherein receiving the first sparse matrix comprises:
receiving a sparse-matrix representation encoded based on a compressed sparse row (CSR), a compressed sparse column (CSC), a dictionary of keys (DOK), a list of list (LIL), or a coordinate list (COO); and
decoding the first sparse matrix from the sparse-matrix representation.

26. The system of claim 25, wherein the at least one processor is further configured to execute the instructions to cause the system to perform:
decoding the second sparse matrix using the first array, the second array, the third array, and a fourth array if the inference status meets the predetermined condition, wherein the sparse-matrix representation comprises the fourth array.
